(19) United States
(12) Patent Application Publication
(10) Pub. No.: US 2026/0083621 A1
(43) Pub. Date: Mar. 26, 2026

(54) PNEUMATIC COMPRESSION DEVICE

(71) Applicant: Therabody, Inc., Los Angeles, CA (US)

(72) Inventors: Jaime SANCHEZ SOLANA, Los Angeles, CA (US); Benjamin NAZARIAN, Beverly Hills, CA (US); Washington Alexander SILVA GARCES, Los Angeles, CA (US); Brian ZENG, Dongguan City (CN); Alan YU, Dongguan City (CN); Jacky PAN, Dongguan City (CN); Timothy ROBERTS, Sarasota, FL (US)

(21) Appl. No.: 18/990,808

(22) Filed: Dec. 20, 2024

Related U.S. Application Data
(63) Continuation of application No. PCT/CN2024/119908, filed on Sep. 20, 2024.

(51) Int. Cl. A61H 9/00; A61H 23/02

(52) U.S. Cl. CPC A61H 9/0092; A61H 23/02; A61H 2201/10; A61H 2201/1238; A61H 2201/165; A61H 2201/5025; A61H 2205/10; A61H 2205/12

(57) ABSTRACT

A compression therapy device includes an inflatable body enclosing an elongate passage. The elongate passage defines an interior of the compression therapy device. The compression therapy device also includes a liner attached to the inflatable body. The liner includes a window. The compression therapy device also includes an elongate infrared emitter configured to emit infrared radiation away from the inflatable body and into the passage through the window. The elongate infrared emitter is substantially aligned with a lengthwise direction of the elongate passage.

### CROSS-REFERENCE TO RELATED APPLICATIONS

This application is a continuation of International Application No. PCT/CN2024/119908, filed Sep. 20, 2024, the entirety of which is incorporated by reference herein.

### BACKGROUND

Compression therapy devices are frequently used in pairs to apply simultaneous therapy to symmetrical features of a user. For example, a user may use two compression therapy boots at the same time to apply therapy to both legs. Using two compression therapy devices at the same time in this manner entails using two of each component of each compression therapy device. For example, both compression therapy devices may include all of the same user interface elements, which can be unnecessary and potentially confusing when a user wishes to use both compression therapy devices at the same time.

While compression therapy is beneficial for recovering from physical activity and treating soft tissue, it is not the only type of treatment useful for those purposes. Existing compression therapy devices generally enclose the portion of the body being treated, thereby preventing access with other therapeutic tools. Users of existing compression therapy devices seeking to apply other treatments as well must apply those other treatments separately from compressive therapy, which increases the amount of time needed to apply all intended treatments.

### SUMMARY

Accordingly, there may be a need for providing new methods and devices for providing simultaneous compression therapy to multiple portions of a user without using redundant user interfaces. There may also be a need for providing new methods and devices for applying secondary therapies concurrently with compression therapy. Aspects of the present disclosure relate to a compression therapy device comprising elements for providing one or more secondary therapies. The secondary therapy elements can be positioned around an interior of the device. The device can be one of two devices in a system that comprises a leader device and a follower device. The leader device can comprise a control panel sufficient to control operation of both the leader device and the follower device. The follower device can have simpler control elements that do not duplicate all of the functions of the control panel of the leader compression therapy device.

Some aspects of the present disclosure relate to a compression therapy device. The compression therapy device may comprise an inflatable body enclosing an elongate passage defining an interior of the compression therapy device. The compression therapy device may also comprise a liner attached to the inflatable body, wherein the liner comprises a window. The compression therapy device may also comprise an elongate infrared emitter configured to emit infrared radiation away from the inflatable body and into the passage through the window, wherein the elongate infrared emitter is substantially aligned with a lengthwise direction of the elongate passage.

In some embodiments according to the foregoing, the inflatable body may comprise an interior facing side. The infrared emitter may be disposed between the window and the interior facing side.

In some embodiments according to any of the foregoing, the elongate infrared emitter may be a first elongated infrared emitter. The compression therapy device may comprise a plurality of elongate infrared emitters, and the plurality of elongate infrared emitters comprises the first elongate infrared emitter and additional elongate infrared emitters. The plurality of elongate infrared emitters may be arranged about the elongate passage with the additional elongate infrared emitters extending substantially parallel to the first elongate infrared emitter.

In some embodiments according to any of the foregoing, the compression therapy device may comprise motor shells attached to the liner and interspersed among the plurality of elongate infrared emitters. The compression therapy device may also comprise vibration motors, wherein a respective one of the vibration motors is disposed within each motor shell.

In some embodiments according to any of the foregoing, each of the motor shells may be constructed of a rigid material.

In some embodiments according to any of the foregoing, wherein the liner may comprise an emitter cover extending across the window to define a pocket between the emitter cover and the window. The elongate infrared emitter may be received in the pocket.

In some embodiments according to any of the foregoing, the pocket may comprise an open end. The compression therapy device may comprise an elastic restrictor positioned at the open end and configured to resist withdrawal of the elongate infrared emitter through the open end.

Some aspects of the present disclosure relate to a compression therapy system. The compression therapy system may comprise a leader device. The leader device may comprise a first compression sleeve, a first pump configured to inflate an inflatable body, and a controller configured to control the first pump. The first compression sleeve may comprise the inflatable body. The compression therapy system may also comprise a follower device. The follower device may comprise a second compression sleeve, a second inflatable body comprised by the second compression sleeve, and a second pump configured to inflate the second inflatable body. The controller may be configured to control the second pump.

In some embodiments according to any of the foregoing, the leader device may comprise a first infrared emitter. The controller may be configured to control the first infrared emitter. The follower device may comprise a second infrared emitter. The controller may be configured to control the second infrared emitter.

Some aspects of the present disclosure relate to a compression therapy system. The compression therapy system may comprise a leader device. The leader device may comprise a first compression sleeve. The leader device may also comprise a first pump configured to inflate the first compression sleeve. The leader device may also comprise a first controller mounted to the first compression sleeve and configured to control the first pump. The compression therapy system may also comprise a follower device. The follower may device comprise a second compression sleeve. The follower device may also comprise a second pump configured to inflate the second compression sleeve. The follower device may also comprise a second controller mounted to the second compression sleeve and configured to control the second pump. The compression therapy system may also comprise a user interface system that is asymmetric with respect to the leader device and the follower device. The user interface system may comprise a first control panel mounted to the first compression sleeve. The first controller may be configured to receive user inputs through the first control panel and relay commands based on the user inputs to the second controller such that the first controller controls the second pump through the second controller.

In some embodiments according to any of the foregoing, the leader device may comprise a first infrared emitter configured to emit infrared radiation into an interior of the first compression sleeve. The follower device may comprise a second infrared emitter configured to emit infrared radiation into an interior of the second compression sleeve. The first controller may be configured to control the first infrared emitter. The first controller may be configured to control the second infrared emitter through the second controller.

In some embodiments according to any of the foregoing, the first control panel may comprises a first user interface layout, the user interface system comprises a second control panel comprising a second user interface layout that differs from the first user interface layout, and the second control panel is mounted to the second compression sleeve.

In some embodiments according to any of the foregoing, the first control panel may comprises a first user interface layout, and wherein the follower device lacks any control panel comprising the first user interface layout.

Some aspects of the present disclosure relate to a compression therapy device. The compression therapy device may comprise a sleeve. The sleeve may comprise an inflatable body. The sleeve may define an interior space that the inflatable body is configured to constrict, and the inflatable body comprises an interior facing side. The compression therapy device may also comprise a liner attached to the inflatable body and positioned to cover a portion of the interior facing side of the inflatable body. The compression therapy device may also comprise infrared emitters connected to the liner and arranged circumferentially about the interior space. The compression therapy device may also comprise vibration motors connected to the liner and arranged circumferentially about the interior space and between the infrared emitters.

In some embodiments according to any of the foregoing, the compression therapy device may comprise a controller configured to control the vibration motors. The controller may be configured to only activate the vibration motors when the inflatable body is inflated to at least a predetermined internal pressure.

In some embodiments according to any of the foregoing, the compression therapy device may comprise rigid motor shells attached to the liner, wherein each of the vibration motors is attached to the liner by being received within a respective one of the rigid motor shells.

In some embodiments according to any of the foregoing, the rigid motor shells may be located between the liner and the interior facing side.

In some embodiments according to any of the foregoing, the infrared emitters may comprise a first infrared emitter configured to emit infrared radiation away from the interior facing side of the inflatable body through the liner.

In some embodiments according to any of the foregoing, liner may comprise a sheet, a slot formed in the sheet, and a window transparent to a spectrum of infrared radiation. The first infrared emitter may be configured to emit infrared radiation through the window.

Some aspects of the present disclosure relate to a compression therapy system comprising the compression therapy device according to any of the foregoing. The compression therapy device may be a follower compression therapy device. The sleeve may be a follower sleeve configured to receive a first limb of a user. The inflatable body may be a follower inflatable body. The compression therapy system may also comprise a leader compression therapy device. The leader compression therapy device may comprise a leader controller and a leader sleeve that comprises a leader inflatable body. The leader sleeve may be configured to receive a second limb of the user. The leader sleeve may define an interior space that the inflatable body is configured to constrict. The leader controller may be configured to control the infrared emitters and the vibration motors of the follower compression therapy device.

Further features and advantages, as well as the structure and operation of various embodiments, are described in detail below with reference to the accompanying drawings. It is noted that the specific embodiments described herein are not intended to be limiting. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the pertinent art to make and use the disclosure.

FIG. 1 is a perspective view of a compression therapy device according to an aspect of the present disclosure.

FIG. 2 is a diagrammatic representation of certain features of a compression sleeve according to some aspects of the present disclosure in cross section.

FIG. 3 illustrates an inflation sequence of the compression sleeve of FIG. 2.

FIG. 4 is a perspective view of the compression therapy device of FIG. 1.

FIG. 5 is a front elevation view of the compression therapy device of FIG. 1 in an open configuration.

FIG. 6 is a perspective view of the compression therapy device of FIG. 1 in a partially disassembled state.

FIG. 7 is a perspective view of a portion of a liner of the compression therapy device of FIG. 1.

FIG. 8A is a cross-sectional view of an interior portion of the compression therapy device of claim 1.

FIG. 8B is a cross-sectional view of an interior portion of the compression therapy device of claim 1.

FIG. 9A is a top plan view of an infrared emitter.

FIG. 9B is a side cross-sectional view of the infrared emitter of FIG. 9A.

FIG. 10A is a diagram of placement of secondary therapeutic elements on a liner of the compression therapy device of FIG. 1.

FIG. 10B is a diagram of placement of secondary therapeutic elements on the liner of FIG. 10.

FIG. 11A is a perspective view of a compression therapy system.

FIG. 11B is a perspective view of the compression therapy system of FIG. 11A.

FIG. 12A is a flowchart of an operating process for a leader compression therapy device.

FIG. 12B is a flowchart of an operating process for a follower compression therapy device.

Embodiments of the present disclosure will be described with reference to the accompanying drawings.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment might not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this disclosure, the term “module” may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

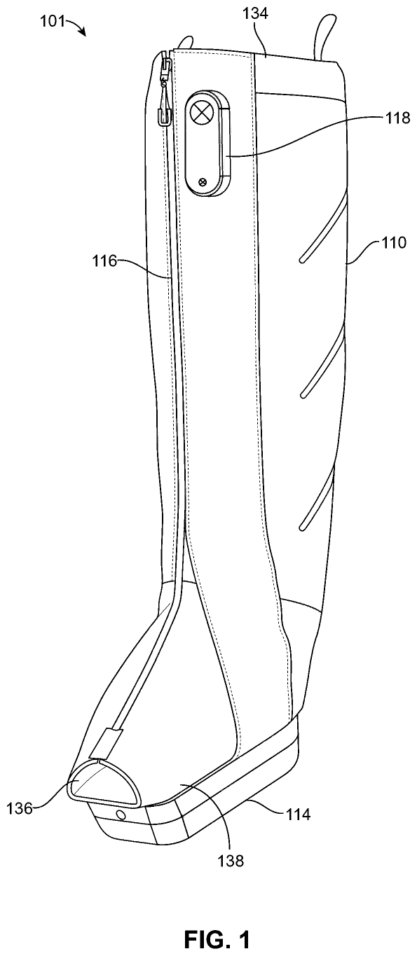

FIG. 1 illustrates a compression therapy device 101. Compression therapy device 101 comprises a sleeve 110 configured to pneumatically compress a portion of a wearer. Sleeve 110 of the illustrated example is configured to receive and compress a leg and foot of a wearer, and thus gives compression therapy device 101 the overall form of a boot. However, in other examples, sleeve 110 can be configured otherwise, such as for receiving and compressing an arm of a wearer.

Sleeve 110, 130 of the illustrated example includes a seam 116 that can be opened to facilitate donning and removing compression therapy device 101. Seams 101 can be selectively fastenable, such as with a zipper or other selective closure elements. In other embodiments, seam 116 can be positioned otherwise, or other features can be provided instead of seam 116 to facilitate donning and removing compression therapy device 101.

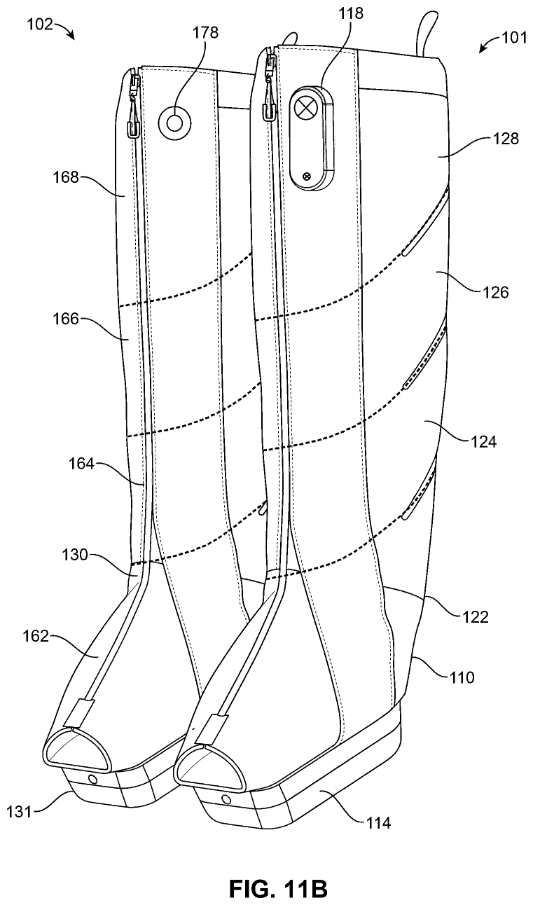

Compression therapy device 101 also comprises a control assembly 118. Control assembly 118 comprises a control panel 119, described further below with respect to FIG. 11A, that acts as a user interface for controlling compression therapy device 101. In the illustrated example, control assembly 118 is mounted to sleeve 110 nearer to proximal end 134 of sleeve 110 than to distal end 136 of sleeve 110. Control assembly 118 thus provides an easily accessible way for a user to control compression therapy device 101 while wearing compression therapy device 101. However, control assembly 118 may be located elsewhere in other examples.

Compression therapy device 101 also comprises a pump 114 mounted to a bottom surface 138 of a foot portion of sleeve 110. Pump 114 and its connection to sleeve 110 can be alike in any respects to the pump assembly and connection thereof to the compression sleeve described in U.S. patent application Ser. No. 17/588,570, filed Jan. 31, 2022, the entirety of which is hereby incorporated by reference. Positioning pump 114 on bottom surface 138 of the foot portion of sleeve 110 as shown can make any noise produced by the operation of pump 114 less audible to a wearer of device 101 because of the nearness of bottom surface 138 to a distal end 136 of sleeve 110. Thus, pump 114 can be positioned nearer to a distal end 136 of sleeve 110 than to proximal end 134 of sleeve 110. Pump 114 can also be positioned nearer to distal end 136 of sleeve 110 than proximal end 134 of sleeve 110 in some other embodiments wherein sleeve 110 is configured to receive and compress a limb other than a leg, such as an arm. However, in further embodiments, pump 114 can be positioned elsewhere, including near to proximal end 134 of sleeve 110.

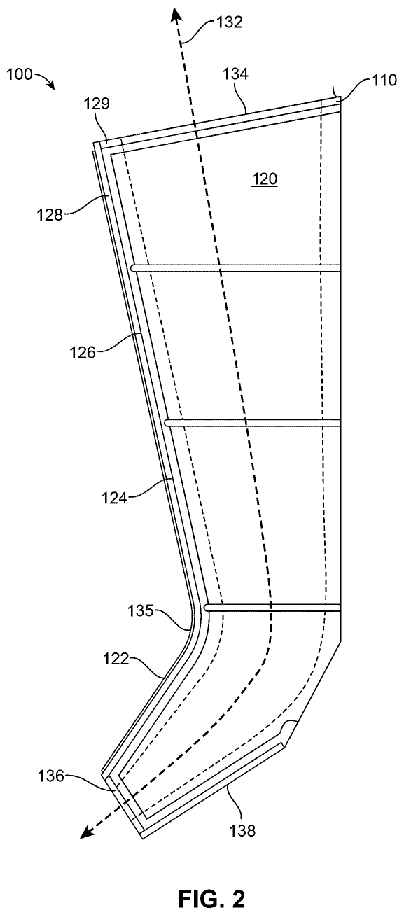

FIG. 2 diagrammatically represents certain features of sleeve 110 in cross section. Sleeve 110 comprises inflatable body 129. Inflatable body 129 encloses an elongate passage defining an interior 120 of compression therapy device 101. Interior 120 is configured to receive a limb of a wearer. Inflatable body 129 is configured to constrict interior 120 when inflated.

A longitudinal line 132 is defined with respect to interior 120. Longitudinal line 132 extends along a center of area of interior 120 from proximal end 134 to distal end 136 of sleeve 110. Longitudinal line 132 is therefore also a proximal-distal line of sleeve 110.

Proximal end 134 and distal end 136 are defined with respect to proximal and distal ends of the limb that sleeve 110 is configured to receive an intended position of receipt for the limb. Thus, in the illustrated example wherein sleeve 110 is configured to receive a leg of a wearer, distal end 136 of sleeve 110 is configured to receive a wearer's toes when sleeve 110 is worn. Distal end 136 can therefore be distinct from a bottom surface 138 of a foot portion of sleeve 110. Similarly, proximal end 134 of sleeve 110 is an end from which a wearer's thigh extends when sleeve 110 is worn.

Because sleeve 110 of the illustrated example curves at an ankle portion 135 to accommodate an angle of a natural resting position of a foot relative to a calf, longitudinal line 132 of the illustrated example is not entirely straight. A longitudinal, proximal, or distal direction relative to any portion of sleeve 110 is accordingly defined tangent to a nearest point along longitudinal line 132. The shape of sleeve 110 can vary for other embodiments configured to receive other portions of a wearer or to accommodate design considerations. Thus, longitudinal line 132 in other embodiments may be entirely straight, may bend at more than one location, or may branch.

Inflatable body 129 comprises a series of inflatable chambers arranged along longitudinal line 132. Inflatable body 129 of the illustrated example comprises four such inflatable chambers, including a first inflatable chamber 122, a second inflatable chamber 124, a third inflatable chamber 126, and a fourth inflatable chamber 128 in order from distal-most to proximal-most. In some embodiments, inflatable body 129 comprises exactly four such inflatable chambers. Each inflatable chamber extends around a respective portion of interior 120 and can therefore constrict the portion of interior 120 when inflated. In the illustrated example, first inflatable chamber 122 is configured to receive and compress a wearer's foot, while second inflatable chamber 124, third inflatable chamber 126, and fourth inflatable chamber 128 are each configured to receive and compress a respective portion of a wearer's leg. Inflatable chambers can be apportioned differently in other examples.

At least an interior 120 facing side of each of the inflatable chambers 122, 124, 126, 128 is constructed of flexible material so that the inflatable chambers will expand into interior 120 when inflated. Inflatable body 129 can thereby constrict interior 120 as inflatable chambers 122, 124, 126, 128 are inflated.

Inflatable body 129 according to other examples can comprise different numbers of inflatable chambers. Moreover, instead of individual inflatable chambers that extend around a respective portion of interior 120, inflatable bodies 128 according to other examples can comprise multiple inflatable chambers at certain longitudinal positions along interior 120, said multiple inflatable chambers each being located at a different circumferential position about interior 120 to collectively surround interior 120.

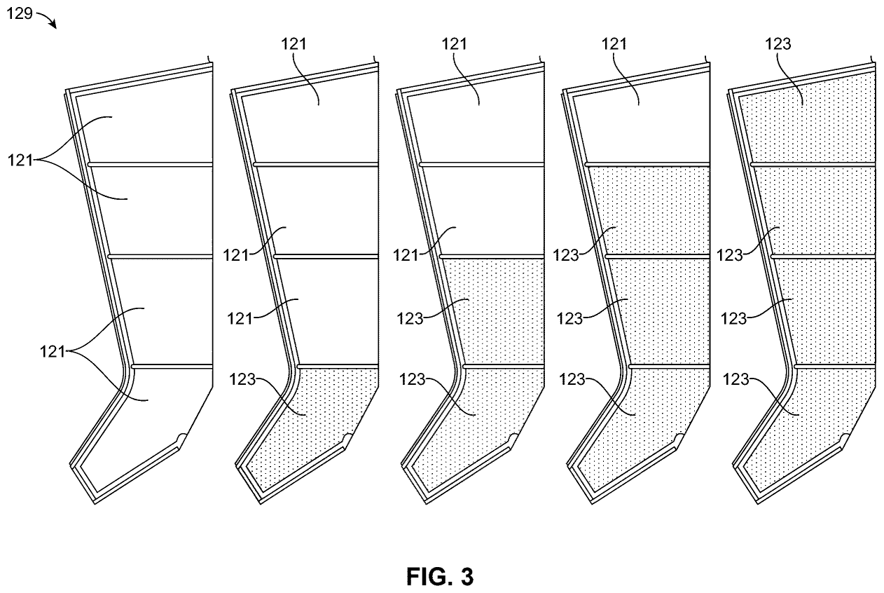

Sleeve 110 can be operated through an inflation cycle comprising an inflation sequence shown in FIG. 3. Compression therapy device 101 can be configured to execute an inflation cycle by alternating the inflation sequence shown in FIG. 3 and a deflation sequence. At an initial state before the inflation sequence, all inflatable chambers of sleeve 110 can be deflated chambers 121. The inflation sequence can then begin by first inflating a distal-most inflatable chamber, thereby converting the distal-most inflatable chamber from a deflated chamber 121 to an inflated chamber 123. The inflation sequence can then progress by sequentially inflating each deflated chamber 121 to an inflated chamber 123 in order from distal-most to proximal-most until all inflatable chambers of sleeve 110 are inflated chambers 123.

By inflating the inflatable chambers in order from distal to proximal, then deflating the inflatable chambers, the inflation cycle can apply compression to the compressed limb in a manner that drives blood from the wearer's extremities to the wearer's core, which is associated with a number of therapeutic benefits. Additionally, the cyclical application and removal of compression to the limb in sleeve 110 can massage the limb's muscles and provide additional therapeutic benefits.

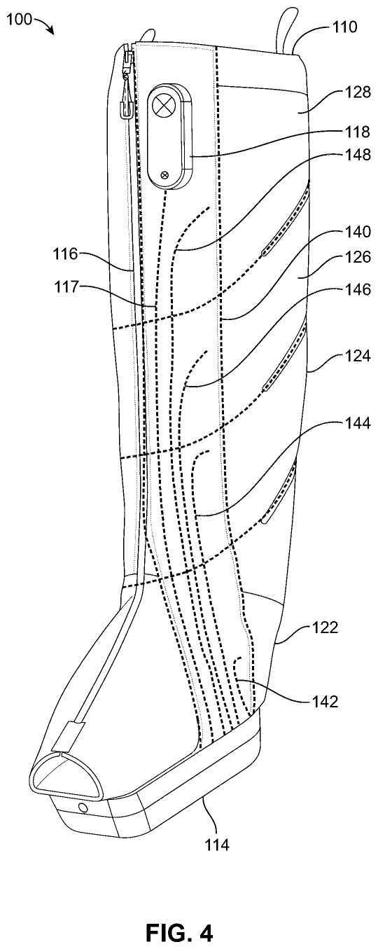

Turning to FIG. 4, sleeve 110 comprises air conduits extending from pump 114 to each of the inflatable chambers 122, 124, 126, 128. Sleeve 110 comprises a first air conduit 142 connecting pump 114 to first inflatable chamber 122. Sleeve 110 comprises a second air conduit 144 connecting pump 114 to inflatable chamber 124. Sleeve 110 comprises a third air conduit 146 connecting pump 114 to third inflatable chamber 126. Sleeve 110 comprises a fourth air conduit 148 connecting pump 114 to fourth inflatable chamber 128. Thus, sleeve 110 comprises a respective air conduit for each inflatable chamber 122, 124, 126, 128. The number of inflatable chambers comprised by sleeve 110 can vary in other embodiments, and the number of air conduits comprised by sleeve 110 can vary proportionally.

Sleeve 110 also comprises a wire 117 for communicating control signals between control assembly 118 and pump 114. Wire 117 extends from control assembly 118 to pump 114. In other embodiments, control assembly 118 can control pump 114 wirelessly. In some such other embodiments, sleeve 110 can lack a wire for communicating control signals between control assembly 118 and pump 114.

Sleeve 110 of the illustrated example comprises a pocket 140 extending along the inflatable chambers 122, 124, 126, 128 from pump 114. The air conduits 142, 144, 146, 148 extend from pump 114 to the respective inflatable chambers 122, 124, 126, 128 through pocket 140. Routing air conduits 142, 144, 146, 148 through pocket 140 in this manner can contribute to a sleek appearance of compression therapy device 101 and protect air conduits 142, 144, 146, 148 from interference.

Pocket 140 of the illustrated example also extends from control assembly 118 to pump 114. Wire 117 can therefore also extend through pocket 140. Routing wire 117 through pocket 140 in this manner can also contribute to the appearance of compression therapy device 101 and protect wire 117 from interference.

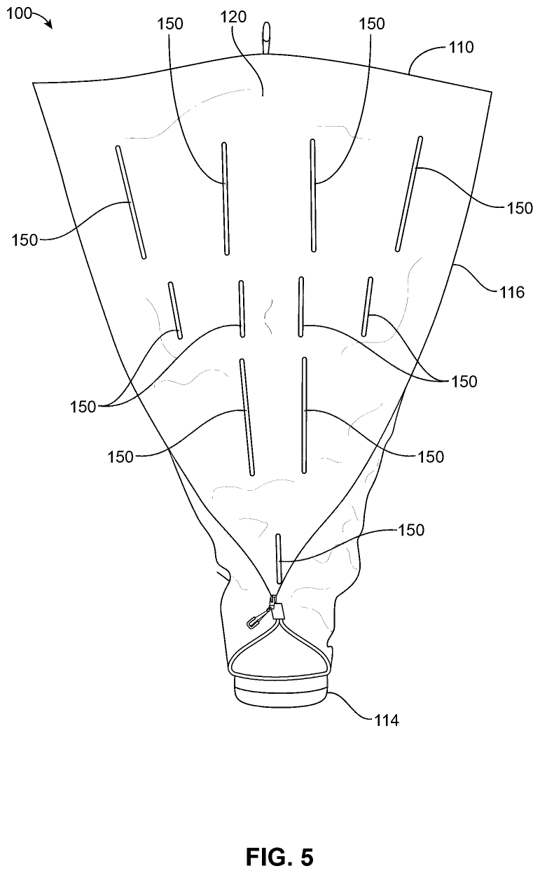

FIG. 5 shows compression therapy device 101 with seam 116 unclosed so that a portion of sleeve 110 is spread flat. As shown in FIG. 5 compression therapy device 101 comprises infrared emitters 150 directed toward interior 120. Infrared emitters 150 are arranged on an inner side of sleeve 110. Thus, when seam 116 is closed such that sleeve 110 encloses interior 120, infrared emitters 150 are arranged around interior 120.

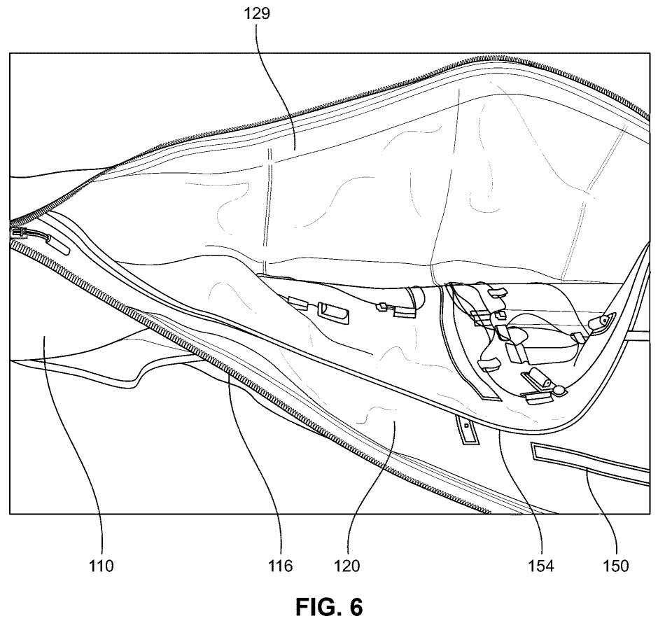

As shown in FIG. 6, sleeve 110 comprises a liner 154. Liner 154 is configured to line the inside of inflatable body 129. Liner 154 therefore surrounds interior 120 when seam 116 is closed such that sleeve 110 encloses interior 120. In some embodiments, liner 154 can be constructed of flexible material suitable for skin contact. In some such embodiments, liner 154 is constructed of material that is resistant to moisture retention and bacterial growth. One example of a suitable material is thermoplastic polyurethane (“TPU”), though liner 154 can be constructed of any of a wide variety of materials. In further examples, liner 154 can be constructed of nylon coated in TPU. For example, all interior 120 facing surfaces of liner 154 can comprise TPU or TPU coating so that TPU will form the only portions of liner 154 that will contact a wearer's skin during ordinary use.

Liner 154 of the illustrated example is configured to attach to inflatable body 129 adjacent each side of seam 116. Liner 154 of the illustrated example therefore spans the interior 120 facing side of inflatable body 129 when fully attached to inflatable body 129. Liner 154 can therefore cover inflatable body 129 from the inside and prevent direct contact between inflatable body 129 and a limb received in interior 120. Liner 154 can thereby make compression therapy device 101 more comfortable to use and easier to clean.

Liner 154 of the illustrated example can be separable from inflatable body 129 to facilitate cleaning of liner 154 and access to components disposed between liner 154 and inflatable body 129. In other embodiments, liner 154 can be permanently attached to inflatable body 129.

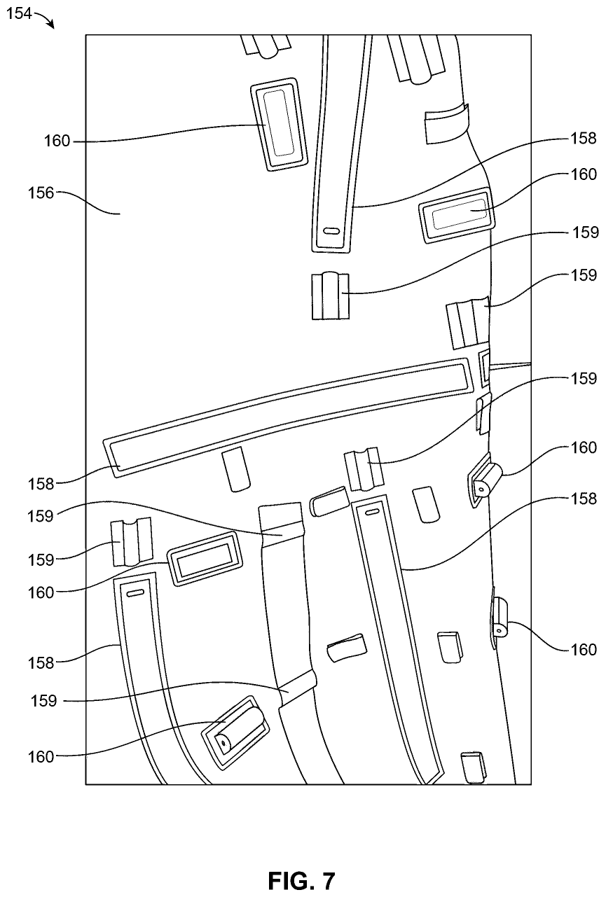

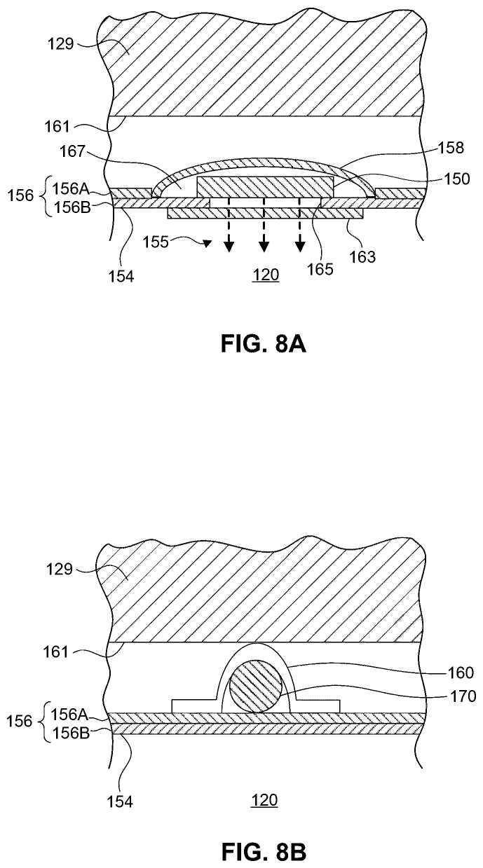

FIG. 7 shows a portion of a side of liner 154 configured to face inflatable body 129. Liner 154 comprises emitter covers 158. Emitter covers 158 cover a back of infrared emitters 150 installed in liner 154. Motor shells 160 are attached to liner 154. Motor shells 160 are configured to retain vibration motors 170 to liner 154, as described further below with respect to FIG. 8B.

Cable restrictors 159 can be attached to liner 154 to restrict cables for powering infrared emitters 150 and the vibration motors 170. Cable restrictors 159 can thereby contribute to keeping the wiring of compression therapy device 101 organized. Cable restrictors 159 can be elastic to allow the wires, infrared emitters 150, and vibration motors 170 some freedom of movement.

Cable restrictors 159 can be positioned adjacent to open ends of pockets defined under emitter covers 158. Cable restrictors 159 can thereby also inhibit infrared emitters 150 from backing out of the pockets defined under emitter covers 158. The pockets defined under emitter covers 158 can each be closed at an end opposite from the open end, causing emitters 150 to tend to remain between the closed end and the cable restrictor 159 positioned adjacent to the open end.

Cable restrictors 159 can also be positioned adjacent to open ends of motor shells 160. Cable restrictors can thereby also inhibit the vibration motors 170 from backing out of motor shells 160. Motor shells 160 can each be closed at an end opposite from the open end, causing the vibration motors 170 to remain between the closed end and the cable restrictor 159 positioned adjacent to the open end.

FIG. 8A shows an emitter pocket 167 formed in liner 154 in cross-section. Liner defines a pocket 167 for each infrared emitter 150. Liner 154 comprises a window 163 for each emitter cover 158 and each infrared emitter 150. Infrared emitter 150 is disposed between window 163 and an interior facing side 161 of inflatable body 129. Liner 154 also comprises an emitter cover 158 for each infrared emitter 150. An emitter pocket 167 is formed between each window 163 and emitter cover 158. Each emitter pocket 167 is configured to receive an infrared emitter 150.

Liner 154 comprises a sheet 156. Sheet 156 can further comprise a non-contact layer 156A and a contact layer 156B. Non-contact layer 156A can be configured to face inflatable body 129, and therefore to remain out of contact with a wearer's skin during ordinary use. Contact layer 156B can be configured to face interior 120 and may therefore contact a wearer's skin during ordinary use.

As noted above, moisture and bacteria resistant materials can be advantageous when used for portions of liner 154 expected to contact a wearer's skin. Accordingly, contact layer 156B may be constructed of TPU or a similar material, or may comprise another material such as nylon that is coated on an interior 120 facing side with TPU or a similar material.

Non-contact layer 156A can also be constructed of nylon, TPU, or nylon coated in TPU. In further examples, non-contact layer 156A can be constructed of other materials, including materials that would be undesirable for inclusion in contact layer 156B, because non-contact layer 156A will not contact a wearer's skin in ordinary use.

Because contact layer 156B is expected to contact a wearer's skin, stitching of any element to contact layer 156B may be minimized or avoided entirely to give contact layer 156B a smooth surface. The resulting smooth surface may be more comfortable for skin contact than a surface with a large amount of stitching.

A slot 165 is formed in contact layer 156B of sheet 156 for each infrared emitter 150. A window 163 covers each slot 165. Windows 163 can be constructed of material transparent to at least a therapeutic spectrum within the spectrum of infrared radiation 155 infrared emitters 150 are configured to emit. Infrared emitters 150 can therefore emit infrared radiation 155 through liner 154 into interior 120. Specifically, emitters 150 can emit infrared radiation 155 through windows 163 of liner 154 into interior 120.

Windows 163 can be attached to either side of contact layer 156B. In the illustrated example, windows 163 are attached to the interior 120 facing side of contact layer 156B. Windows 163 of the illustrated example therefore cover the edges of slots 165 and prevent a wearer from directly contacting the edges. However, in some other examples, windows 163 can be attached to the inflatable body 129 facing side of sheet 156.

Windows 163 can be attached to sheet 156 by welding or heat bonding to avoid stitching or seams between windows 163 and contact layer 156B. Attaching windows 163 by welding or heat bonding can reduce the perceptibility of the edges of windows 163 and slots 165 to a wearer. Windows 163 can be attached to sheet 156 by other ways in other examples.

Emitter covers 158 can be formed in sheet 156 where non-contact layer 156A extends over slots 165. In particular, an emitter cover 158 can be formed as a portion of non-contact layer 156A that is not connected to contact layer 156B and extends over a slot 165 to form an emitter pocket 167 between the emitter cover 158 and window 163 at the slot 165. Non-contact layer 156A can further comprise an opening at an end of each slot 165, and be joined to contact layer 156B adjacent to each slot, to form emitter pocket 167. Non-contact layer 156A can be joined to contact layer 156B at those locations by welding or heat bonding to avoid stitching in contact layer 156B. An infrared emitter 150 is received in each emitter pocket 167.

Emitter covers 158 and infrared emitters 150 can be disposed on an opposite side of sheet 156 from window 163. Thus, infrared emitter 150 can be located between sheet 156 and an interior facing side 161 of inflatable body 129. This arrangement can minimize a perceptibility of the presence of infrared emitter 150 to a user of compressive therapy device 101.

FIG. 8B shows an end view of a motor shell 160 attached to sheet 156 of liner 154. Motor shell 160 can be joined to non-contact layer 156A specifically. Because non-contact layer 156A is not expected to contact a wearer's skin, motor shells 160 can be joined to non-contact layer 156A with stitching. In some examples, the stitching does not extend into contact layer 156B.

Each motor shell 160 receives a vibration motor 170. Thus, compressive therapy device 101 comprises vibration motors 170, and motor shells 160 attach vibration motors 170 to liner 154. As a result, inflatable body 129 can press vibration motors 170 into engagement with a limb received in interior 120 when inflatable body 129 is inflated. Pressing vibration motors 170 into engagement with the limb in this manner can improve the efficacy of vibration therapy provided by vibration motors 170.

In some embodiments, compressive therapy device 101 can be configured to prevent activation of vibration motors 170 except when inflatable body 129 is inflated to at least a predetermined internal pressure. Vibration motors 170 according to some embodiments can generate a significant amount of noise when not pressed against a surface or object, so preventing vibration motors 170 from activating except when inflatable body 129 is inflated to at least a predetermined internal pressure can reduce noise generated by compression therapy device 101. Moreover, because vibration motors 170 according to some embodiments can have difficulty transferring vibration to treated tissue until pressed onto the treated tissue with requisite force, preventing activation of vibration motors 170 until inflatable body 129 is inflated to at least a predetermined internal pressure may reduce noise while having little to no impact on the quality of vibration therapy provided by compression therapy device 101. In some embodiments, the predetermined internal pressure can be in a range from 10 mmHg to 30 mmHg. In some further embodiments, the predetermined internal pressure can be 20 mmHg.

Motor shells 160 and vibration motors 170 can be located between liner 154 and inflatable body 129. Vibration motors 170 can thus be positioned so that inflatable body 129 can press vibration motors 170 into engagement with a limb received in interior 120 when inflatable body 129 is inflated, but acute pressure on the limb at the location of each vibration motor 170 is alleviated by the position of liner 154 between vibration motor 170 and the limb. However, in other embodiments, motor shells 160 and vibration motors 170 can be located on an interior 120 facing side of liner 154.

Motor shells 160 can define an arcuate shape for receiving and retaining vibration motors 170. The arcuate shape can be dimensioned to provide an interference fit for vibration motor 170 between liner 154 and motor shell 160, thereby causing friction to retain vibration motor 170 within motor shell 160. In some embodiments, motor shells 160 can provide structural support for vibration motors 170, as well as noise dampening of noise generated by vibration motors 170.

Motor shells 160 can be constructed of a rigid material, such as a plastic or rubber material with enough rigidity to maintain the arcuate shape when no vibration motor 170 is received within motor shell 160. Motor shells 160 constructed of relatively rigid materials may be capable of better transfer of vibration therapy to the treated body part than more flexible alternatives. Motor shells 160 made from certain such relatively rigid materials, such as rubber or certain plastics, may also have advantageous heat insulating properties, thus preventing heat from leaking from vibration motors 170 to inflatable body 129.

In some embodiments, vibration motors 170 can comprise a weight rotatable about an axis to create vibration. In some such embodiments, the axis can extend parallel to sheet 156 of liner 154. Vibration motors 170 can be elongate in shape, generally like the motor shells 160 as shown in FIG. 7.

In some embodiments, compression therapy device 101 can be configured to control vibration motors 170 to operate at variable speeds. For example, vibration motors 170 may be variable speed motors controlled by a controller 115 of compression therapy device 101, described further below with respect to FIG. 11A. In some embodiments, compression therapy device 101 may be configured to control motors 170 to operate at any speed within a predetermined range. In some further embodiments, compression therapy device 101 may be configured to control motors 170 to operate at speeds among a plurality of predetermined speeds.

In some embodiments, compression therapy device 101 may be configured to control vibration motors 170 to operate at variable speeds through pulse width modulation. The operation speeds of vibration motors 170 may be defined with respect to percentages of a predetermined maximum pulse width. For example, in some embodiments, compression therapy device 101 may be configured to control motors 170 to operate at speeds among a plurality of predetermined speeds, and the plurality of predetermined speeds can comprise a 20% pulse width speed, a 50% pulse width speed, and a 100% pulse width speed, with each percentage being a percentage of the predetermined maximum pulse width.

To protect vibration motor 170 and control hardware, compression therapy device 101 may be configured to ramp motor speed up to the intended operation speed steadily upon activation of a vibration motor 170. Similarly, compression therapy device 101 may be configured to ramp motor speed down to zero from the intended operation speed steadily prior to deactivation of a vibration motor 170. The ramp time for activation, deactivation, or both can be a predetermined time. The predetermined time can be, for example, one second, two seconds, three seconds, four seconds, or any other amount of time. In some embodiments, the ramp time can be proportional to the intended operation speed of the vibration motor 170. In other embodiments, the ramp time can be constant regardless of the intended operation speed of the vibration motor 170.

Infrared therapy and vibration therapy are both secondary therapies to the primary compression therapy provided by compression therapy device 101. Compression therapy device 101 according to some embodiments can therefore be a compression therapy device configured to provide secondary therapy. Compression therapy device 101 according to some further embodiments can be a compression therapy device configured to provide multiple forms of secondary therapy in addition to compression therapy.

Infrared emitters 150 can therefore be considered secondary therapy devices. Vibration motors 170 can therefore also be considered secondary therapy devices. Compression therapy device 101 according to some embodiments is therefore a compression therapy device comprising a liner 154 for an interior 120 configured to receive a limb of a wearer, wherein secondary therapy devices are installed on the liner 154. In some further embodiments, the secondary therapy devices comprise two different types of secondary therapy devices configured to provide different types of compressive therapy. In some further embodiments, the secondary therapy devices comprise infrared emitters 150 and vibration motors 170. In some further embodiments, the two different types of secondary therapy comprise infrared therapy and vibration therapy.

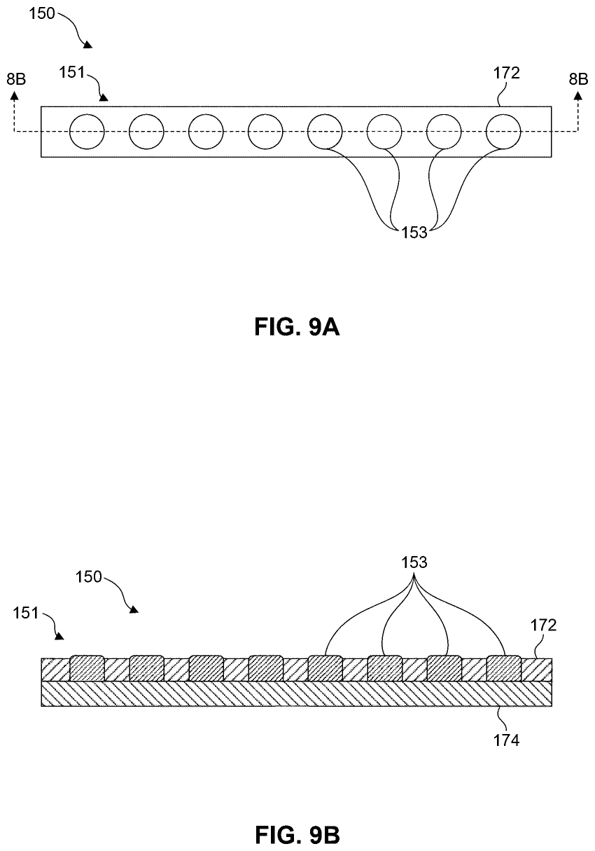

FIGS. 9A and 9B show an infrared emitter 150 according to some embodiments. Infrared emitter 150 comprises a panel 151 and a series of infrared lights 153 supported by the panel 151. Infrared lights 153 can be, for example, light emitting diodes (“LEDs”). In other examples, infrared lights 153 can be any other type of infrared radiation generator. Infrared lights 153 can emit infrared radiation having wavelengths in a range of 840-860 nm. Infrared lights 153 can emit infrared radiation having a power density in a range of 70-150 mW/cm². In some embodiments, infrared emitter 150 can comprise one or more lights that emit visible light in addition to infrared lights 153.

Infrared emitter 150 of the illustrated example comprises eight infrared lights 153. Infrared emitters 150 according to other examples can comprise different quantities of infrared lights 153. For example, infrared emitters 150 according to some embodiments comprise eight total lights, including one visible spectrum light and seven infrared lights 153. In some embodiments, infrared emitters 150 with different numbers of lights can be included in compressive therapy device 101. For example, compression therapy device 101 according to some embodiments can comprise some infrared emitters 150 comprising eight lights, including at least one infrared light 153 and any number of visible spectrum lights, and other infrared emitters 150 comprising four lights, including at least one infrared light 153 and any number of visible spectrum lights. Including infrared emitters 150 with different numbers of lights and different overall sizes can enable the use of relatively long infrared emitters 150 for efficiency where enough space is available while using relatively short infrared emitters 150 where the longer infrared emitters 150 cannot fit, such as near areas where liner 154 will need to bend at a sharp angle.

Panel 151 comprises a backing layer 174. Backing layer 174 can comprise, for example, a printed circuit board (“PCB”).

Panel 151 also comprises a reinforcing layer 172. Reinforcing layer 172 is applied to backing layer 174 to inhibit bending of backing layer 174. Reinforcing layer 172 can be constructed of any material capable of resiliently resisting bending stress. Reinforcing layer 172 can comprise, for example, silicone.

Reinforcing layer 172 of the illustrated example is applied to a side of backing layer 174 upon which infrared lights 153 are supported. Reinforcing layer 172 accordingly has openings defined therein and aligned with infrared lights 153 to prevent reinforcing layer 172 from covering infrared lights 153. Reinforcing layer 172 thereby inhibits leakage of infrared radiation from infrared lights 153 in unintended directions in addition to inhibiting bending of panel 151. Infrared lights 153 are therefore configured to emit infrared radiation through reinforcing layer 172. Infrared lights 153 of the illustrated example also extend through reinforcing layer 172.

The elongate shape of infrared emitters 150 facilitates providing infrared therapy across a curved surface area without requiring infrared emitters 150 to bend. For embodiments of compression therapy device 101 configured for treatment of arms and legs, interior 120 can be roughly cylindrical in shape. In such embodiments, infrared emitters 150 can be arranged roughly parallel to longitudinal line 132. Emitter pockets 167 can be formed in liner 154 to receive infrared emitters in that arrangement. With multiple infrared emitters 150 arranged around longitudinal line 132 while extending roughly parallel to longitudinal line 132, infrared emitters 150 can provide a suitable distribution of infrared radiation to a limb received in interior 120 without any of the infrared emitters 150 needing to be significantly curved.

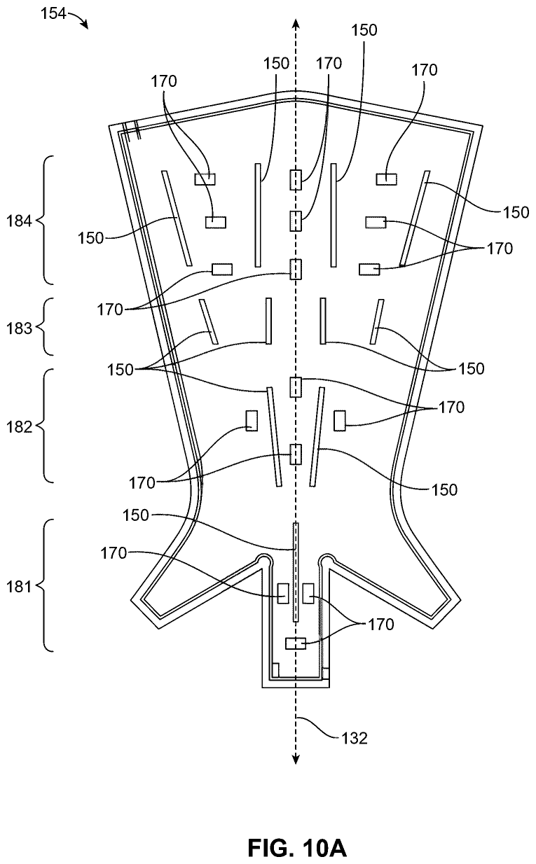

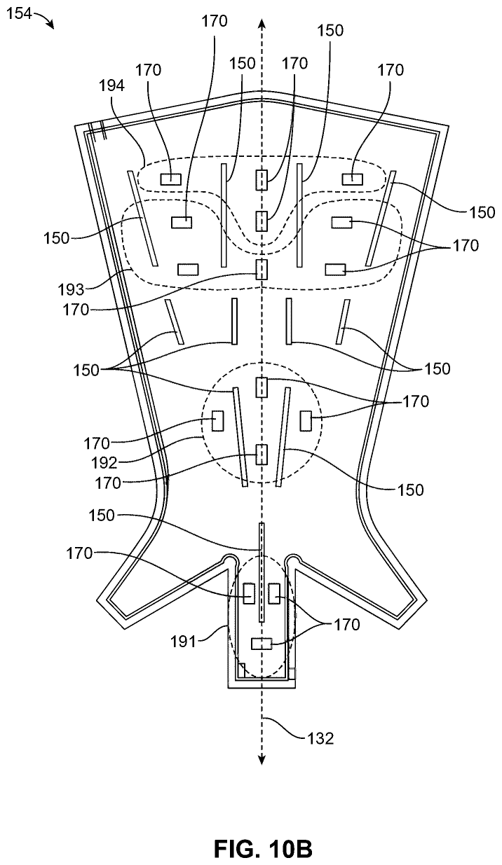

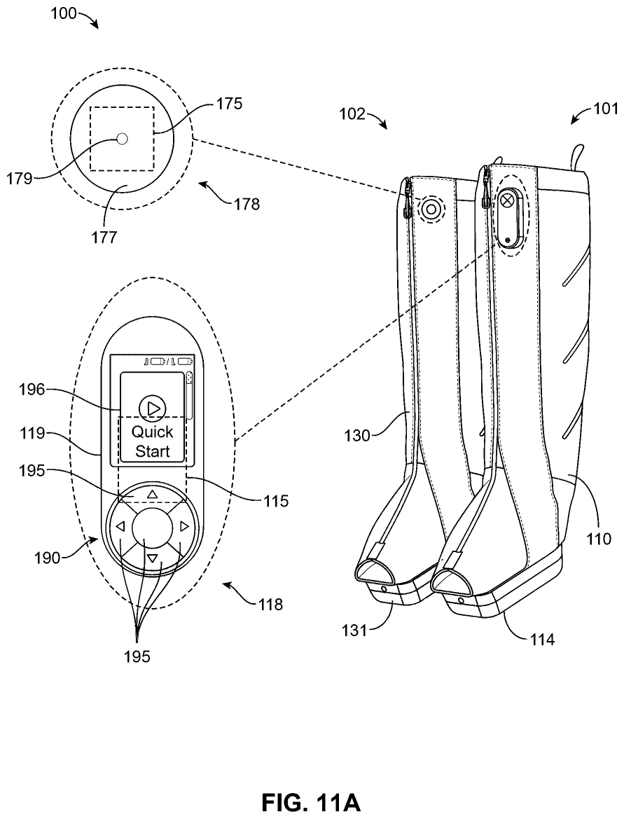

Infrared emitters 150 and vibration motors 170 can be arranged on liner 154 in a predetermined pattern as shown in FIGS. 10A and 10B, which show the liner 154 laid flat on a plane.

As shown in FIG. 10A, infrared emitters 150 can be arranged in groups 181, 182, 183, 184. In the illustrated example, each of the emitter groups 181, 182, 183, 184 comprises at least one infrared emitter 150 at a location along longitudinal line 132. First emitter group 181 is a distal-most emitter group and is positioned on liner 154 to provide infrared therapy to a wearer's foot. Fourth emitter group 184 is a proximal-most emitter group and is positioned on liner 154 to provide infrared therapy to a wearer's thigh. Second emitter group 182 is positioned on liner 154 proximally of first emitter group 181 and distally of fourth emitter group 184 to provide infrared therapy to a wearer's calf. Third emitter group 183 is positioned on liner 154 proximally of first infrared emitter group 181 and second infrared emitter group 182 and distally of fourth emitter group 184 to provide infrared therapy to a wearer's knee. In other examples, the number and placement of emitter groups can vary to provide different distributions of infrared therapy and to be appropriate for treating different portions of a wearer's body.

In the illustrated example, emitter groups 181 comprise various numbers of infrared emitters 150. In the illustrated example, first emitter group 181 comprises one infrared emitter 150, second infrared emitter group 182 comprises two infrared emitters 150, third emitter group 183 comprises four infrared emitters 150, and fourth emitter group 184 comprises four infrared emitters 150. In some embodiments, compressive therapy device 101 may be configured to activate or deactivate every infrared emitter 150 in an emitter group simultaneously. In some further embodiments, compressive therapy device 101 can be configured to activate or deactivate emitter group 181, 182, 183, 184 independently from one another.

In the illustrated example, each emitter group that comprises multiple infrared emitters 150 comprises a row of infrared emitters 150 at a respective location along longitudinal line 132. This configuration causes the multiple infrared emitters 150 within a single emitter group to be located at different circumferential locations at a single longitudinal location when liner 154 is installed in sleeve 110 and sleeve 110 is closed about interior 120 as shown above in FIG. 2. The multiple infrared emitters 150 within a single emitter group can therefore distribute infrared radiation circumferentially around a portion of a limb received in interior 120 of sleeve 110.

Infrared emitters 150 are arranged on liner 154 to be substantially parallel to longitudinal line 132. In this context, substantially parallel means extending in a direction 20° or less away from strictly parallel. Infrared emitters 150 of the illustrated embodiment are also arranged on liner 154 to be substantially parallel to each other.

Infrared emitters 150 are shown to be substantially parallel to longitudinal line 132 and each other in FIG. 10A, which shows liner 154 flat on a plane. In some embodiments, infrared emitters 150 are also arranged on liner 154 to extend substantially parallel to longitudinal line 132 when liner is installed in sleeve 110 and sleeve 110 is closed about interior 120 as shown in FIG. 2. As noted above with respect to FIG. 2, longitudinal line 132 is not entirely straight in the configuration of FIG. 2, so the direction of longitudinal line 132 at any location is tangent to longitudinal line 132 itself at that location. The substantially parallel position of any infrared emitter 150 is defined relative to such a tangent direction at a nearest point along longitudinal line 132.

As shown in FIG. 10B, vibration motors 170 can also be arranged in motor groups 191, 192, 193, 194. Vibration motors 170 are interspersed among infrared emitters 170. Each motor 170 is disposed within a respective motor shell 160 as described above with respect to FIG. 8B. Thus, motor shells 160 are also interspersed among infrared emitters 150, with a vibration motor 170 being disposed within each motor shell.

Returning to FIG. 10B, motor groups 191, 192, 193, 194 can be positioned to target muscles of a limb received in compression therapy device 101. In the illustrated example, each of the motor groups 191, 192, 193, 194 comprises at least one vibration motor 170.

In the illustrated example, the vibration motors 170 within each group are positioned near to one another, though not necessarily all at a same longitudinal position. Vibration motors 170 arranged in a group can be spaced circumferentially apart to distribute vibration therapy across a circumference of a portion of a wearer treated by that group.

First motor group 191 is a distal-most motor group and is positioned on liner 154 to provide vibration therapy to a wearer's foot. Fourth motor group 194 is a proximal-most motor group and is positioned on liner 154 to provide vibration therapy to a first portion of a wearer's thigh. Second motor group 192 is positioned on liner 154 proximally of first motor group 191 and distally of fourth motor group 194 to provide vibration therapy to a wearer's calf. Third motor group 193 is positioned on liner 154 proximally of first motor group 191 and second motor group 192 and distally of fourth motor group 194 to provide vibration therapy to a second portion of wearer's knee. The first portion of the wearer's thigh and second portion of the wearer's thigh may overlap longitudinally while the second portion of the wearer's thigh extends distally of the first portion of the wearer's thigh. In other examples, the number and placement of motor groups can vary to provide different distributions of vibration therapy and to be appropriate for treating different portions of a wearer's body.

In some embodiments, compressive therapy device 101 may be configured to activate or deactivate every vibration motor 170 in a motor group simultaneously. In some further embodiments, compressive therapy device 101 can be configured to activate or deactivate motor groups 191, 192, 193, 194 independently from one another.

As noted above, compression therapy device 101 can be configured to prevent activation of vibration motors 170 when inflatable body 129 is insufficiently inflated. In some embodiments, compression therapy device 101 can be configured to prevent activation of vibration motors 170 at certain locations when a specific one of the inflatable chambers 122, 124, 126, 128 of inflatable body 129 is insufficiently inflated. Thus, in some embodiments, depending on an inflation state of each of the inflatable chambers, compression therapy device 101 may be configured to prevent activation of some vibration motors 170 and permit activation of some other vibration motors 170 according to the inflation states of the inflatable chambers.

In some embodiments, compression therapy device 101 can be configured to prevent activation of a vibration motor 170 if a nearest one of the inflatable chambers 122, 124, 126, 128 is not inflated to at least a predetermined internal pressure.

In some further embodiments, compression therapy device 101 can be configured to prevent or permit activation of vibration motors 170 on a motor group basis. Thus, compression therapy device 101 may be configured to prevent or permit activation of each of the motor groups 191, 192, 193, 194 individually depending on inflation states of inflatable chambers 122, 124, 126, 128 relevant to each motor group.

Thus, in some embodiments, compression therapy device 101 may be configured to prevent first motor group 191 from activating when first inflatable chamber 122 is not inflated to at least a predetermined internal pressure. In some further embodiments, compression therapy device 101 may be configured to enable activation of first motor group 191 when first inflatable chamber 122 is inflated to at least the predetermined internal pressure, regardless of the inflation states of any other inflatable chambers.

In some embodiments, compression therapy device 101 may be configured to prevent second motor group 192 from activating when second inflatable chamber 124 is not inflated to at least a predetermined internal pressure. In some further embodiments, compression therapy device 101 may be configured to enable activation of second motor group 192 when second inflatable chamber 124 is inflated to at least the predetermined internal pressure, regardless of the inflation states of any other inflatable chambers.

In some embodiments, compression therapy device 101 may be configured to prevent third motor group 193 from activating when third inflatable chamber 126 is not inflated to at least a predetermined internal pressure. In some further embodiments, compression therapy device 101 may be configured to enable activation of third motor group 193 when third inflatable chamber 126 is inflated to at least the predetermined internal pressure, regardless of the inflation states of any other inflatable chambers.

In some embodiments, compression therapy device 101 may be configured to prevent fourth motor group 194 from activating when fourth inflatable chamber 128 is not inflated to at least a predetermined internal pressure. In some further embodiments, compression therapy device 101 may be configured to enable activation of fourth motor group 194 when second inflatable chamber 128 is inflated to at least the predetermined internal pressure, regardless of the inflation states of any other inflatable chambers.

Thus, in some embodiments, compression therapy device 101 may be configured to prevent or permit activation of each motor group 191, 192, 193, 194 depending on the inflation state of a different part of inflatable body 129. In some embodiments, compression therapy device 101 may be configured to prevent or permit activation of each motor group 191, 192, 193, 194 depending on the inflation state of a single inflatable chamber of inflatable body 129. In some embodiments, compression therapy device 101 may be configured to prevent or permit activation of each motor group 191, 192, 193, 194 depending on the inflation state of a different, single inflatable chamber 122, 124, 126, 128 of inflatable body 129.

As noted above, compression therapy device 101 may be configured to ramp operation speed of vibration motors 170 up and down steadily upon activation of vibration motors 170 and prior to deactivation of vibration motors 170. The activity of vibration motors 170 in some embodiments may therefore lag the inflation and deflation of inflatable chambers 122, 124, 126, 128. For example in embodiments wherein inflatable chambers 122, 124, 126, 128 are individually inflated and deflated at different times, each motor group 191, 192, 193, 194 may reach its intended operating speed at a time delayed from the inflation of the corresponding inflatable chamber or chambers, and each motor group 191, 192, 193, 194 may cease operation at a time delayed from the deflation of the corresponding inflatable chamber or chambers.

In order to account for the above-mentioned delay between inflatable chambers 122, 124, 126, 128 and motor groups 191, 192, 193, 194, compression therapy device 101 may be configured to begin ramping the operation speed of any motor group 191, 192, 193, 194 before completion of inflation or deflation of the corresponding inflatable chamber or chambers 122, 124, 126, 128. For example, during a protocol comprising both compression and vibration therapy, compression therapy device 101 can be configured to begin ramping up speed of a motor group a predetermined amount of time before inflation of the corresponding inflatable chamber is expected to be complete or a predetermined amount of time after inflation of the corresponding inflatable chamber has begun. Similarly, during a protocol comprising both compression and vibration therapy, compression therapy device 101 can be configured to begin ramping down speed of a motor group a predetermined amount of time before deflation of the corresponding inflatable chamber is expected to be complete or a predetermined amount of time after deflation of the corresponding inflatable chamber has begun.

As shown in FIG. 11A, a compression therapy system 100 can comprise the compression therapy device 101 described above. Within compression therapy system 100, compression therapy device 101 can be a leader compression therapy device 101.

Compression therapy system 100 can also comprise a follower compression therapy device 102. Where leader compression therapy device 101 can be configured to receive and compress a first limb of a wearer, follower compression therapy device 102 can be configured to receive and compress a second limb of the wearer. Follower compression therapy device 102 can be alike to leader compression therapy device 101 in all respects other than lacking the leader control assembly 118 of leader compression therapy device 101. Instead of leader control assembly 118, follower compression therapy device 102 can comprise a follower control assembly 178. Thus, other than leader control assembly 118, follower compression therapy device 102 can comprise all of the elements described above with respect to leader compression therapy device 101, and those elements in follower compression therapy device 102 may function as described above with respect to leader compression therapy device 101. Thus, in some embodiments, any therapies that leader compression therapy device 101 may provide can also be provided by follower compression therapy device 102. In some such embodiments, compression therapy system 100 can comprise synchronizing therapies between leader compression therapy device 101 and follower compression therapy device 102.

Follower compression therapy device 102 may therefore comprise, for example, a sleeve 130 configured to receive a limb of a wearer. Follower control assembly 178 can be mounted to sleeve 130. The sleeve 130 may comprise an inflatable body configured to compress the received limb. Follower compression therapy device 102 may also comprise a pump 131 configured to inflate the inflatable body. Follower compression therapy device 102 may also comprise secondary therapeutic devices such as infrared emitters and vibration motors, and a liner for the interior of the sleeve. For any elements wired to leader control assembly 118 in leader compression therapy device 101, the corresponding elements in follower compression therapy device 102 may be wired to follower control assembly 178 instead. For example, pump 131 can be wired to follower control assembly 178 to communicate control signals between follower control assembly 178 and pump 131.

In the illustrated example, system 100 is a compression therapy system, making the leader device a leader compression therapy device 101 and the follower device a follower compression therapy device 102. However, the workflows, pairing, and intercommunication functions described herein with respect to leader compression therapy device 101 and follower compression therapy device 102 may be applied to other types of leader devices and follower devices. Thus, for each reference to leader compression therapy device 101 and follower compression therapy device 102 in description of those functions, a leader device and a follower device of another type are contemplated.

Turning to FIG. 11B, sleeve 130 of follower compression therapy device 102 can comprise an equal number of inflatable chambers to sleeve 110 of leader compression therapy device 101. The inflatable chambers of follower compression therapy device 102 can also be sized and arranged in the same manner as the inflatable chambers of leader compression therapy device 101. Follower compression therapy device 102 can therefore cooperate with leader compression therapy device 101 to provide symmetrical compression therapy to two limbs.

Follower compression therapy device 102, for example, comprises four such inflatable chambers, including a first inflatable chamber 162, a second inflatable chamber 164, a third inflatable chamber 166, and a fourth inflatable chamber 168 in order from distal-most to proximal-most. In some embodiments, follower compression therapy device 102 comprises exactly four such inflatable chambers. Each inflatable chamber extends around a respective portion of an interior of sleeve 130 and can therefore constrict the portion of interior 120 when inflated. The inflatable chambers of follower compression therapy device 102 may further be arranged along a longitudinal line defined relative to the interior of sleeve 130 in the same manner that longitudinal line 132 is defined relative to interior 120 of sleeve 110 of leader compression therapy device 101.

In the illustrated example, first inflatable chamber 162 is configured to receive and compress a wearer's foot, while second inflatable chamber 164, third inflatable chamber 166, and fourth inflatable chamber 168 are each configured to receive and compress a respective portion of a wearer's leg. Inflatable chambers can be apportioned differently in other examples.

As noted above, the inflatable chambers of follower compression therapy device 102 are configured to be symmetrical to the inflatable chambers of leader compression therapy device 101. First inflatable chamber 162 of follower compression therapy device 102 may therefore be symmetrical to first inflatable chamber 122 of leader compression therapy device 101. Similarly, second inflatable chamber 164, third inflatable chamber 166, and fourth inflatable chamber 168 of follower compression therapy device 102 may be symmetrical to second inflatable chamber 124, third inflatable chamber 126, and fourth inflatable chamber 128 of leader compression therapy device 101. In some embodiments, each inflatable chamber in each of the compression therapy devices can also be individually symmetrical so that leader compression therapy device 101 and follower compression therapy device 102 can be applied to either of two limbs to be treated. This symmetry can make compression therapy system 100 equally convenient for both right handed and left handed users.

Returning to FIG. 11A, with continued reference to FIG. 11B, leader control assembly 118 comprises a leader control panel 119 and a leader controller 115. Leader control panel 119 is configured to receive user inputs for controlling functions of both leader compression therapy device 101 and follower compression therapy device 102. Leader control panel 119 can therefore be configured to receive user inputs for controlling functions of compression therapy system 100 as a whole. Leader control panel 119 can be further configured to communicate the received user inputs to controller 115. Leader control panel 119 can therefore be considered part of a user interface system for compression therapy system 100 as a whole.

For the purpose of receiving user inputs, leader control panel 119 of the illustrated example comprises an input array 190 comprising leader buttons 195. Leader control panel 119 can be configured to send a different signal to leader controller 115 for each leader button 195 actuated and thereby allow a user to send a variety of inputs to leader controller 115 by actuating leader buttons 195. In some embodiments, leader buttons 191 can be configured to send signals for navigating menus, adjusting therapeutic parameters, starting or stopping therapeutic protocols, powering either compression therapy device 101, 102 on or off, powering compression therapy system 100 on or off, or any combination of the foregoing. In other embodiments, input array 190 can comprise other devices for receiving inputs in addition to or instead of leader buttons 195, such as switches, rollable elements, or a touch sensitive interface.

Leader controller 115 can store therapeutic protocols. In some embodiments, the protocols can comprise preset protocols programmed into leader controller 115 upon manufacture. In some further embodiments, the protocols can comprise preset protocols distributed in software or firmware updates for leader controller 115. In some further embodiments, the protocols can comprise custom protocols programmed by a user.

The protocols can comprise applying any of the types of therapy compression therapy system 100 is configured to provide, individually or in any combination. Thus, the therapeutic protocols can comprise, for example, compression therapy alone, infrared therapy alone, vibration therapy alone, a combination of compression therapy and infrared therapy, a combination of compression therapy and vibration therapy, a combination of infrared therapy and compression therapy, or a combination of compression therapy, infrared therapy, and vibration therapy.

In addition to comprising different therapies or different combinations of therapies, the protocols can also comprise different parameters for the provided therapies. For any type of applied therapy, the parameters that may differ between protocols can comprise duration of the therapy and intensity of the therapy. For example, protocols comprising compression therapy can differ in the duration of the compression therapy and in the internal pressure of the inflatable body 129 during the compression therapy. Protocols comprising infrared therapy can differ in the duration of the infrared therapy and in the intensity of the infrared radiation emitted during the infrared therapy. Protocols comprising vibration therapy can differ in the duration of the vibration therapy and in the operating speed of the vibration motors during the vibration therapy.

The protocols can also differ in the location where therapy is applied at any stage of the protocols. For example, some protocols can comprise providing any therapies symmetrically between leader compression therapy device 101 and follower compression therapy device 102, while other protocols can comprise providing any therapies asymmetrically between leader compression therapy device 101 and follower compression therapy device 102. Some protocols may be configured to involve only leader compression therapy device 101. Protocols can differ with respect to which inflatable chambers 122, 124, 126, 128 or which combination of inflatable chambers are to be inflated, and at which times during the protocol each individual chamber is to be inflated or deflated. Protocols can differ with respect to which emitter groups 181, 182, 183, 184 or which combination of emitter groups are to be activated, and at which times during the protocol each individual emitter group is to be activated or deactivated. Protocols can differ with respect to which motor group 191, 192, 193, 194 or which combination of motor groups are to be activated, and at which times during the protocol each individual motor group is to be activated or deactivated.

In some embodiments, compression therapy system 100 may be configured to enable users to program custom protocols by inputting any of the foregoing protocol parameters. In some embodiments, compression therapy system 100 may be configured to enable users to program the custom protocols through control panel 119 and to store the custom protocols on leader controller 115. In some further embodiments, compression therapy system 100 may be configured to enable users to program the custom protocols through an application running on an external electronic device configured to communicate with leader controller 115. In some such embodiments, the custom protocols can be stored either on the external electronic device or on leader controller 115.

Compression therapy system 100 can be configured to set bounds on the parameters that can be input for any custom protocols. Thus, compression therapy system 100 can be configured to prevent a user from programming a custom protocol to apply any therapy for a duration or at an intensity that may be unsafe or outside the capabilities of the hardware of compression therapy system 100. Compression therapy system 100 according to some further embodiments can be configured to prevent a user from programming a custom protocol to apply any therapy at an intensity that is insufficient to provide a therapeutic effect.

In some embodiments, compression therapy system 100 can be configured to enable users to program the custom protocols from a blank template. In some further embodiments, compression therapy system 100 can be configured to enable users to program the custom protocols by modifying preset protocols programmed into leader controller 115 upon manufacture or distributed to leader controller 115 in software or firmware updates.

Leader control panel 119 of the illustrated example is also configured to present information to a user of compression therapy system 100. For that purpose, leader control panel 176 of the illustrated example comprises a display 196. Display 196 is configured to receive signals from leader controller 115 and display information based on the received signals. Leader display 196 can be, for example, a screen, or any other type of display sufficient to display a desired amount of information concerning the operation of compression therapy system 100.

Leader controller 115 can control display 196 to show icons or animations representing the status of compression therapy system 100. For example, controller 115 may control display 196 to show an icon representing a status of leader compression therapy device 101. In further examples, controller 115 may control display 196 to show a battery icon showing a battery charge status of leader compression therapy device 101. Such a battery indicator may include a bar that extends in proportion to a level of charge, an element that changes color as charge state changes, or both.

Leader controller 115 may further control display 196 to indicate whether leader compression therapy device 101 is paired to a follower compression therapy device 102. For example, where leader compression therapy device 101 is paired to a follower compression therapy device 102, leader controller 115 may control display 196 to show an icon representing follower compression therapy device 102. Leader controller 115 may further be configured to control display 196 to display different indicia depending on whether leader compression therapy device 101 is in active communication with a follower compression therapy device 102 or leader compression therapy device 101 is paired to a follower compression therapy device 102 without actively communicating with the follower compression therapy device 102. For example, leader controller 115 may be configured to control display 196 to display a first icon when leader compression therapy device 101 is paired to a follower compression therapy device 102 but not in active communication with follower compression therapy device 102, and to not display the first icon when leader compression therapy device 101 is not paired to a follower compression therapy device 102. Leader controller 115 may further be configured to control display 196 to display a second icon either instead of or in addition to the first icon only when leader compression therapy device 101 is in active communication with follower compression therapy device 102. In some embodiments, the second icon may represent a status of the follower compression therapy device 102, similar to the above described ability of display 196 to show an icon representing a status of leader compression therapy device 101. Thus, in some embodiments, leader controller 115 may be configured to control display 196 to show a battery charge status of follower compression therapy device 102 when leader compression therapy device 101 is in active communication with follower compression therapy device 102.

Leader controller 115 may therefore be configured to control display 196 to have at least three different display states comprising an unpaired state, a paired only state, and an active communication state. In some embodiments, the active communication state can comprise display of the above described second icon. In some further embodiments, the active communication state can further comprise display of the above described first icon. In other embodiments, the active communication state can comprise displaying the second icon without displaying the first icon. In some embodiments, the paired only state can comprise displaying the first icon without the second icon. In some embodiments, the unpaired state can comprise displaying neither the first icon nor the second icon.

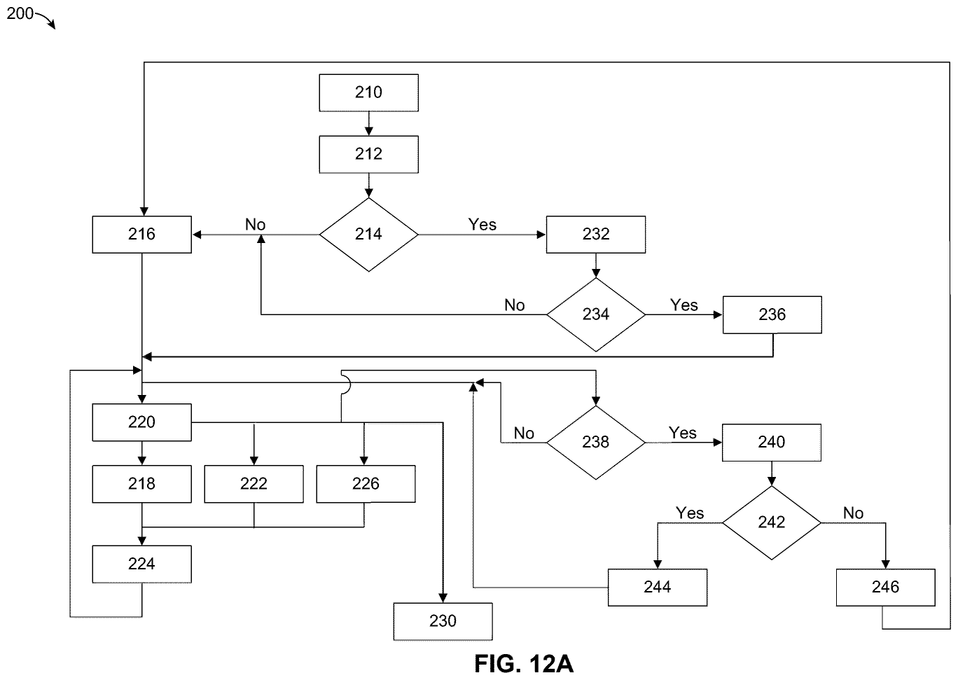

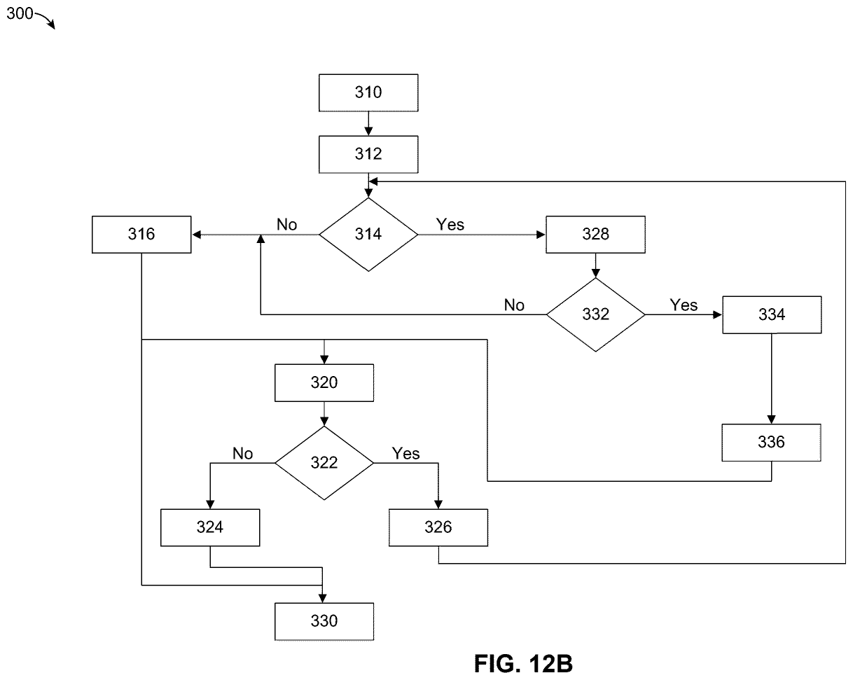

The unpaired, pair only, and active communication display states may appear during different steps of a process 200 described further below with regards to FIG. 12A. For example, leader controller 115 may control display 196 to begin the unpaired display state at unpaired operation step 216. Leader controller 115 may further be configured to control display 196 to begin the paired only display state at follower finding step 232. Leader controller 115 may further be configured to control display 196 to begin the active communication display state at mutual recognition step 236 and at successful pair step 244.

Returning to FIGS. 11A and 11B, leader controller 115 can be configured to control therapeutic functions of leader compressive therapy device 101. Leader controller 115 can therefore be configured to control inflation and deflation of the chambers of inflatable body 129 of leader compression therapy device 101. Leader controller 115 can further be configured to control infrared emitters 150 of leader compression therapy device 101. Leader controller 115 can further be configured to control vibration motors 170 of leader compression therapy device 101.

Follower control assembly 178 can comprise follower controller 175. Follower controller 175 can be configured to control all of the same functions and elements of follower compression therapy device 102 that leader controller 115 can control of leader compression therapy device 101. Follower controller 175 may therefore be configured to control inflation of an inflatable body of follower compression therapy device 102. Follower controller 175 may also be configured to control secondary therapeutic features of follower compression therapy device 102. Thus, follower controller 175 may be configured to control infrared emitters of follower compression therapy device 102. Follower controller 175 may be configured to control vibration motors of follower compression therapy device 102.

Leader controller 115 and follower controller 175 can be in communication in some embodiments. The communication can be wireless communication. For example, in some embodiments, leader controller 115 and follower controller 175 can communicate with each other through a Bluetooth protocol. In other embodiments, leader controller 115 and follower controller 175 can be wired together for wired communication.

Leader controller 115 can be configured to send control instructions to follower controller 175 regarding any control functions that follower controller 175 may execute, and follower controller 175 may be configured to receive control instructions from leader controller 115 regarding any control functions that follower controller may execute. For example, leader controller 115 can be configured to receive user inputs through the leader control panel and relay commands based on the user inputs to follower controller 175. Leader controller 115 can therefore control follower compression therapy device 102 through follower controller 175. For example, leader controller 115 may be configured to control inflation or deflations of any inflatable chambers of follower compression therapy device 102 through follower controller 175. Leader controller 115 may also be configured to control infrared emitters of follower compression therapy device 102 through follower controller 175. Leader controller 115 may also be configured to control vibration motors of follower compression therapy device 102 through follower controller 175.

Follower controller 175 may be configured to communicate information about the status of follower compression therapy device 102 to leader controller 115. For example, follower controller 175 can be configured to communicate any control functions executed by follower controller 175 to leader controller 115. Follower controller 175 can also be configured to communicate any sensor data received by follower controller 175 to leader controller 115.

Leader controller 115 and follower controller 175 may be configured to coordinate to synchronize therapy provided by leader compression therapy device 101 and follower compression therapy device 102. Thus, when leader compression therapy device 101 and follower compression therapy device 102 are used together and a therapeutic protocol is selected through leader control assembly 118, leader controller 115 may instruct follower controller 175 to control follower compression therapy device 102 to follow the same therapeutic protocol at the same time as leader compression therapy device 101.

Compression therapy system 100 may be configured to cause equivalent inflatable chambers in compression therapy devices 101, 102 to inflate at the same time when compression therapy system 100 follows any compression therapy protocol. For example, compression therapy system 100 may be configured to cause first inflatable chamber 162 of follower therapy device 101 to inflate simultaneously with first inflatable chamber 122 of leader compression therapy device 101 when following any compression therapy protocol that includes inflating of first inflatable chamber 122. Compression therapy system 100 may further be configured to cause second inflatable chamber 164 of follower compression therapy device 102 to inflate simultaneously with second inflatable chamber 124 of leader compression therapy device 101, to cause third inflatable chamber 166 of follower compression therapy device 102 to inflate simultaneously with third inflatable chamber 126 of leader compression therapy device 101, and to cause fourth inflatable chamber 168 of follower compression therapy device 102 to inflate simultaneously with fourth inflatable chamber 128 of leader compression therapy device 101 during any compression therapy protocol that includes inflation of any of those inflatable chambers. Compression therapy devices 101, 102 can also be configured to synchronize the deflation of their inflatable chambers in the same manner. Thus, compression therapy system 100 may further be configured to cause first inflatable chamber 162 of follower compression therapy device 102 to deflate simultaneously with first inflatable chamber 122 of leader compression therapy device 101, to cause second inflatable chamber 164 of follower compression therapy device 102 to deflate simultaneously with second inflatable chamber 124 of leader compression therapy device 101, to cause third inflatable chamber 166 of follower compression therapy device 102 to deflate simultaneously with third inflatable chamber 126 of leader compression therapy device 101, and to cause fourth inflatable chamber 168 of follower compression therapy device 102 to deflate simultaneously with fourth inflatable chamber 128 of leader compression therapy device 101 during any compression therapy protocol that includes deflation of any of those inflatable chambers. The inflation state of each inflatable chamber in each compression therapy device 101, 102 may therefore be made to match the inflation state of the corresponding inflatable chamber in the other compression therapy device 101, 102. Compression therapy system 100 may be configured to accomplish such synchronization through communication between leader controller 115 and follower controller 175, wherein leader controller 115 controls pump 114 of leader compression therapy device 101 and sends instructions to follower controller 175, which controls pump 131 of follower compression therapy device 102.

Compression therapy system 100 may further be configured to cause either compression therapy device to pause inflation if the other compression therapy device lags behind in inflation. By pausing inflation of either compression therapy device when the other lags behind, leader controller 115 and follower controller 175 can compensate for incidental differences in inflation speed between leader compression therapy device 101 and follower compression therapy device 102. For example, available manufacturing processes may result in individual compression therapy devices 101, 102 varying slightly in inflation speed. By compensating for such variation among compression therapy devices 101, 102, leader controller 115 and follower controller 175 can prevent the differences in inflation speed from becoming noticeable to a user or affecting treatment.

As an example, compression therapy system 100 can be configured to cause either compression therapy device 101, 102 to pause a compression therapy protocol upon inflating any inflatable chamber to a target pressure if the corresponding inflatable chamber in the other compression therapy device 101, 102 has not yet reached the target pressure. The compression therapy device 101, 102 that has paused the compression therapy protocol may not inflate any inflatable chambers while the other compression therapy device 101, 102 proceeds with the compression therapy protocol.

Compression therapy system 100 can further be configured to allow the compression therapy device 101, 102 having the inflatable chamber below the target pressure to continue the compression therapy protocol until that chamber reaches the target pressure, and to cause both compression therapy devices 101, 102 to proceed with the compression therapy protocol at that time.

For example, compression therapy system 100 may be configured to execute a compression therapy protocol with both leader compression therapy device 101 and follower compression therapy device 102, wherein the compression therapy protocol includes inflating both first inflatable chambers 122, 162 to a target pressure, and to cause leader compression therapy device 101 to pause the compression therapy protocol upon first inflatable chamber 122 reaching the internal pressure if first inflatable chamber 162 of follower compression therapy device 102 has not yet reached the target pressure. Compression therapy system 100 may further be configured to cause follower compression therapy device 102 to continue the compression therapy protocol while leader compression therapy device 101 continues to pause its own execution of the compression therapy protocol. Compression therapy system 100 may further be configured to cause leader compression therapy device 101 to resume the compression therapy protocol, such as by inflating or deflating an inflatable chamber, when first inflatable chamber 162 of follower compression therapy device 102 reaches the target pressure.

Compression therapy system 100 can be configured to enact the above described pausing and resuming of a compression therapy protocol in the same way when an inflatable chamber of follower compression therapy device 102 reaches a target pressure before the corresponding inflatable chamber of leader compression therapy device 101. Thus, compression therapy system 100 may be configured to cause follower compression therapy system 102 to pause a compression therapy protocol if first inflatable chamber 162 reaches a target pressure before first inflatable chamber 122 of leader compression therapy system 101, and to resume the compression therapy protocol when first inflatable chamber 122 reaches the target pressure. Compression therapy system 100 can further be configured to apply this approach for compensating for different inflation speeds the same way to each pair of inflatable chambers, including second inflatable chambers 124, 164, third inflatable chambers 126, 166, and fourth inflatable chambers 128, 168. In some embodiments, compression therapy system 100 can further be configured to compensate for different deflation speeds in the same way by causing either compression therapy device 101, 102 to pause a compression therapy protocol upon deflating an inflatable chamber to a target pressure if the corresponding inflatable chamber has not yet been deflated to the target pressure.

Compression therapy system 100 may be configured to accomplish the above described compensation for differences in inflation and deflation speed through communication between leader controller 115 and follower controller 175. Leader compression therapy device 101 may comprise pressure sensors configured to measure pressure in each inflatable chamber 122, 124, 126, 128, and the pressure sensors may be in communication with leader controller 115. Follower compression therapy device 102 may similarly comprise pressure sensors configured to measure pressure in each inflatable chamber 162, 164, 166, and 168, and the pressure sensors may be in communication with follower controller 175. The pressure sensors in each compression therapy device 101, 102 may be located, for example in each respective inflatable chamber, or at any other location from which the pressure in the chambers may be measured. Each controller 115, 175 may therefore be configured to monitor pressure in each inflatable chamber in its respective compression therapy device 101, 102. Further, controllers 115, 175 may be configured to communicate with each other to enable detection of when an inflation state of any inflatable chamber lags behind the corresponding inflatable chamber in the other compression therapy device 101, 102 during a compression therapy protocol.

Leader controller 115 may be configured to cause display 196 to display information received by leader controller 115 from follower controller 175. A user may therefore be able to discern the states of both leader compression therapy device 101 and follower compression therapy device 102 by observing display 196. For example, in some embodiments, leader controller 115 may be configured to cause display 196 to display information about certain parameters of leader compression therapy device 101, and may further be configured to cause display 196 to display information about the same parameters of follower compression therapy device 102. Thus, in some embodiments, leader controller 115 may be configured to cause display 196 to display information about at least one parameter of leader compression therapy device 101, wherein the at least one parameter comprises battery charge, warnings, firmware version, or any combination of the foregoing. In some further embodiments, leader controller 115 may be configured to cause display 196 to display information about at least one parameter of follower compression therapy device 102, wherein the at least one parameter comprises battery charge, warnings, firmware version, or any combination of the foregoing.

Because a user can use input array 190 to control both leader compression therapy device 101 and follower compression therapy device 102 and can discern the states of both leader compression therapy device 101 and follower compression therapy device 102 by observing display 196, follower control assembly 178 does not need to have hardware for either of those functions. Accordingly, follower control assembly 178 can lack an input array 190 like the input array 190 of leader control assembly 118. Similarly, follower control assembly 178 can lack a display 196 like the display of leader control assembly 118. Thus, a user interface of compression therapy system 100 can be asymmetric with respect to leader compression therapy device 101 and follower compression therapy device 102. The user interface of compression therapy system 100 can be asymmetric in that the user interface of compression therapy system 100 comprises leader control panel 119, which is mounted to leader sleeve 110, with no identical control panel mounted to follower sleeve 130.

In some further embodiments, follower compression therapy device 102 may be incapable of executing any therapeutic functions, such as compression, infrared radiation, or vibration, except when instructed to do so by a leader compression therapy device 101. Thus, in some embodiments, follower compression therapy device 102 cannot operate therapeutic functions independently of a leader compression therapy device 101.

In some embodiments, follower control assembly 178 can comprise relatively simple input hardware. Leader control panel 119 comprises a first user interface layout comprising the input array 190 and display 196, and follower control assembly 178 can lack any control panel comprising the first user interface layout.

In some embodiments, follower control assembly 178 can comprise a second user interface layout that differs from the first user interface layout of leader control panel 119. For example, follower control assembly 178 can comprise a follower button 177. The second user interface layout can comprise follower button 177.

In some embodiments, follower button 177 can act as a power button for follower compression therapy device 102. Thus, in some embodiments, follower button 177 may be configured to switch power of follower compression therapy device 102 on or off when actuated. In further embodiments, follower button 177 can act to enable a wireless communication pairing state for follower compression therapy device 102, such as pairing step 320 described below with respect to FIG. 12B. Thus, in some embodiments, follower controller 175 can be configured to enter a state wherein wireless communication between follower controller 175 and another device, such as leader controller 115, can be established in response to actuation of follower button 177.

Follower controller 175 can be configured to respond differently to different patterns of actuation of follower button 177. For example, follower controller 175 can be configured to execute a first function in response to follower button 177 remaining depressed for at least a first predetermined length of time. In another example, follower controller 175 can be configured to execute a second control function in response to follower button 177 being depressed a predetermined number of times within a second predetermined length of time, wherein the second control function is different than the first control function. Either the first control function or the second control function can comprise switching follower compression therapy device 102 on or off. The other of the first control function or the second control function can comprise placing follower compression therapy device 102 into the wireless communication pairing state.

Follower control assembly 178 can also comprise an indicator 179. The second user interface layout can also comprise indicator 179. Thus, follower control assembly 178 can be considered to comprise a follower control panel having the second user interface layout, wherein the second user interface layout comprises follower button 177 and indicator 179.

Indicator 179 can comprise a light, such as, for example, an LED. In some further embodiments, indicator 179 can comprise a multiple color LED or multiple LEDs of different colors. Follower controller 175 can be configured to cause indicator 179 to output indications of a state of follower compression therapy device 102. The indications can comprise multiple differing illumination states of indicator 179 that correspond to respective differing states of follower compression therapy device 102. For example, follower controller 175 can be configured to cause indicator 179 to enter a first illumination state when follower compression therapy device 102 is powered off. Follower controller 175 can be configured to cause indicator 179 to enter a second illumination state when follower compression therapy device 102 is powered on and follower compression therapy device 102 is in the wireless communication pairing state, such as pairing step 320 described below with respect to FIG. 11B. Follower controller 175 can be configured to cause indicator 179 to enter a third illumination state when follower compression therapy device 102 is powered on and follower compression therapy device 102 is paired to leader compression therapy device 101, such as being in active communication with a leader compression therapy device 101 at paired operation step 336 described below with respect to FIG. 12B. Follower controller 175 can be configured to cause indicator 179 to enter a fourth illumination state when follower compression therapy device 102 is powered on and follower compression therapy device 102 is neither in the pairing state nor currently paired to a leader compression therapy device 101, such as at idle state 316 described below with respect to FIG. 12B.

The first illumination state, second illumination state, and third illumination state differ from one another. Any of the first illumination state, second illumination state, and third illumination state can be an absence of illumination, such that indicator 179 is not illuminated. Another of the illumination states can be indicator 179 remaining steadily illuminated in a first color. In some embodiments, another of the illumination states can comprise indicator 179 being illuminated in a second color that differs from the first color. In some further embodiments, another of the illumination states can comprise indicator 179 being intermittently illuminated and not illuminated.

Compression therapy system 100 according to some embodiments may be configured such that a paired leader compression therapy device 101 and follower compression therapy device 102 may begin active communication with one another automatically upon both leader compression therapy device 101 and follower compression therapy device 102 being powered on. In some embodiments, leader compression therapy device 101 and follower compression therapy device 102 can be paired upon manufacture. Thus, in some embodiments, compression therapy system 100 can be sold as a kit comprising a paired compression therapy leader compression therapy device 101 and follower compression therapy device 102 so that the leader compression therapy device 101 and follower compression therapy device 102 will automatically communicate with each other upon being powered on without additional configuration by the purchaser being necessary. In some such embodiments, leader compression therapy device 101 can be configured to permit a user to cause leader compression therapy device 101 to pair to a different follower compression therapy device 102. In some further embodiments, follower compression therapy device 102 can be configured to permit a user to cause follower compression therapy device 102 to pair to a different leader compression therapy device 101. Thus, a user may be able to replace a leader compression therapy device 101 or a follower compression therapy device 102 in a compression therapy system 100 when needed.

FIG. 12A shows an operating process 200 for leader compression therapy device 101. Operating process 200 can be conducted by leader controller 115. Thus, steps and decisions of operating process 200 can be executed by leader controller 115 except as they relate to functions expressly attributed to a user or to other devices.

Operating process 200 can begin at an off state 210. In off state 210, leader compression therapy device 101 may be powered off. Off state 210 can be ended with an activation step 212. Activation step 212 can comprise powering leader compression therapy device 101 on. Activation step 212 can comprise, for example, flipping a power switch or pressing a power button of leader compression therapy device 101. In some embodiments, the power button can be a leader button 195 of leader control panel 119. As noted above, operating process 200 and its steps can be executed by leader controller 115, except for functions expressly reserved for a user or another device. Thus, to use activation step 212 as an example, a user may be responsible for providing the input that initiates activation step 212, and an on button, on switch, or other input hardware may be the device responsible for receiving the user's activating input, but leader controller 115 may execute startup functions following receipt of the activating input.

At any time after activation step 212, process 200 can proceed to deactivation step 230. Deactivation step 230 can comprise powering leader compression therapy device 101 off. Similar to activation step 212, deactivation step 230 can be initiated by a user providing a deactivating input such as, for example, flipping a power switch or pressing a power button of leader compression therapy device 101. In some embodiments, the power button can be a leader button 195 of leader control panel 119. Deactivation step 230 can be initiated the user providing the deactivation input in instances wherein deactivation step 230 is initiated by a user. However, in certain circumstances, process 200 can proceed automatically to deactivation step 230. In such circumstances, deactivation step 230 can comprise powering leader compression therapy device 101 off automatically, without user input.

Following activation step 212, process 200 can proceed to a current pair decision 214. Current pair decision 214 can comprise leader controller 115 determining whether leader compression therapy device 101 is currently paired to any follower compression therapy device 102 for wireless communication.

If current pair decision 214 results in a finding that no, leader compression therapy device 101 is not currently paired to any follower compression therapy device 102, process 200 can proceed to unpaired operation step 216. Unpaired operation step 216 can comprise leader compression therapy device 101 operating as an individual compression therapy device without sending instructions to a follower compression therapy device 102.

Process 200 proceeds from unpaired operation step 216 to panel control step 220. Panel control step 220 is a phase of process 200 wherein a user may input commands to compression therapy system 100 as a whole or leader compression therapy device 101 alone through leader control panel 119. Compression therapy system 100 and leader compression therapy device 101 can maintain a preexisting paired or unpaired state during panel control step 220. That is, if process 200 reaches panel control step 220 by proceeding from unpaired operation step 216, panel control step 220 can occur while leader compression therapy device 101 remains unpaired. If process 200 reaches panel control step 220 by proceeding from mutual recognition step 236 or successful pair step 244, panel control step 220 can occur while leader compression therapy device 101 is paired to a follower compression therapy device 102. When panel control step 220 occurs while leader compression therapy device 101 is paired to a follower compression therapy device 102, panel control step 220 may comprise leader controller 115 relaying instructions to follower controller 175 based on inputs received through leader control panel 119, thus enabling control of compression therapy system 100 overall through leader control panel 119. If process 200 reaches panel control step 220 by looping back from any protocols 218, 222, 226 or by proceeding from a “no” result at new pair decision 238, compression therapy system 100 and leader compression therapy device 101 may maintain a preexisting paired or unpaired status.

In some embodiments, compression therapy system 100 may optionally be configured to communicate with an external device, such as a mobile electronic device, a smart device, or a computer. The external device may run an application configured to control compression therapy system 100. Accordingly, in some embodiments, any functions described herein as being performed through leader control panel 119 may alternatively be performed through an application running on an external device in communication with compression therapy system 100.

From panel control step 220, a user may cause process 200 to proceed to a variety of other steps by inputting commands to leader control panel 119. For example, a user may cause process 200 to proceed from panel control step 220 to new pair decision 238, and may further input a “yes” or “no” outcome for the new pair decision 238 through leader control panel 119. A user may cause process 200 to proceed from panel control step 220 to deactivation step 230 by inputting a deactivation command through leader control panel 119.

A user may also cause process 200 to proceed from panel control step 220 to application of a therapeutic protocol by selecting a therapeutic protocol through leader control panel 119. Three types of therapeutic protocols 218, 222, 226 are shown in the illustrated example, but any number of therapeutic protocols may be available for selection in various other embodiments. Panel control step 220 may further comprise user adjustment of parameters of any therapeutic protocol before the protocol begins.

Panel control may remain available during the performance of any therapeutic protocol, such as for enabling cancellation of the protocol through inputs to leader control panel 119, switching to a different protocol through inputs to leader control panel 119, or adjusting parameters of a therapeutic protocol while the protocol is ongoing.

Depending on the pair state of leader compression therapy device 101, the therapeutic protocol selected at panel control step 220 can be performed either by leader compression therapy device 101 alone if leader compression therapy device 101 is unpaired or by both leader compression therapy device 101 and follower compression therapy device 102, and thus compression therapy system 100 as a whole, if leader compression therapy device 101 is paired to a follower compression therapy device 102.

In some embodiments, at least one of the therapeutic protocols selectable from panel control step 220 can comprise compression therapy. In some embodiments, at least one of the therapeutic protocols selectable from panel control step 220 can comprise infrared therapy. In some embodiments, at least one of the therapeutic protocols selectable from panel control step 220 can comprise vibration therapy.

In some embodiments, types of therapeutic protocols available for selection from panel control step may comprise a quick start protocol 218, a muscle protocol 222, and a joint protocol 226. Each of the types of protocols 218, 222, and 226 may further comprise multiple specific protocols. For example, quick start protocols 218 may comprise a variety of saved presets. Muscle protocols 222 may comprise a variety of protocols for treating different muscle groups or seeking specific outcomes, such as pre-exercise warmup or sleep preparation. Joint protocols 226 may comprise multiple protocols for treating different joints or applying different types of therapies to joints.

Process 200 may loop back to panel control step 220 after completing any protocol 218, 222, 226. Process 200 may optionally pass through save default step 224 between the protocol 218, 222, 226 and panel control step 220. Thus, save default step 224 may be omitted entirely in some embodiments, and process 200 may return to panel control step 220 directly from any protocol 218, 222, 226. In further embodiments, leader compression therapy device 101 may be configured such that process 200 will proceed directly from at least one type of protocol 218, 222, 226 to panel control step 220, but will proceed from at least one other type of protocol 218, 222, 226 to save default step 224 before returning to panel control step 220. For example, in some embodiments, leader compression therapy device 101 may be configured such that process 200 will proceed from quick start protocol 218 to save default step 224 before returning to panel control step 220, but process 200 will return directly from any other type of protocol 222, 226 to panel control step 220. Thus, a user may be able to save one or more favored treatments as quick start protocols 218 that may be freely adjustable, while other types of therapeutic protocols 222, 226 may be set permanently. By keeping some protocols set permanently, leader compression therapy device 101 may be programmed with some reliable therapeutic protocols that may be based on research or on guidance from medical professionals and other therapeutic practitioners while the user may be free to adjust other protocols based on personal goals and preferences.

Save default step 224 can comprise saving any user adjustments to therapeutic parameters to a therapeutic protocol such that the therapeutic protocol will be performed according to those parameters when next selected, unless the user makes further adjustments to that protocol before that time. Thus, in some examples, a user may be able to adjust therapeutic parameters such as duration, intensity, location, and sequence of any of the types of therapy that compression therapy system 100 may be capable of providing.

If current pair decision 214 results in a decision of yes, leader compression therapy device 101 is paired to a follower compression therapy device 102, process 200 may proceed to follower finding step 232. Follower finding step 232 can comprise leader compression therapy device 101 attempting to establish active communication with the paired follower compression therapy device 102. Process 200 may proceed from follower finding step 232 to follower finding decision 234. Follower finding decision 234 can comprise a determination of whether leader compression therapy device 101 was able to establish active communication with the paired follower compression therapy device 102. If follower finding decision 234 results in a decision of no, leader compression therapy device 101 was not able to establish active communication with the paired follower compression therapy device 102, process 200 may proceed to unpaired operation step 216. If follower finding decision 234 results in a decision of yes, leader compression therapy device 101 was able to establish active communication with the paired follower compression therapy device 102, process 200 can proceed to mutual recognition step 236. In mutual recognition step 236, leader compression therapy device 101 and follower compression therapy device 102 confirm each other's identities and continue active communication. Process may proceed from mutual recognition step 236 to panel control step 220.

Process 200 may proceed from mutual recognition step 236 to new pair decision 238. New pair decision 238 can comprise a determination based on user inputs of whether to establish a new pair link between leader compression therapy device 101 and a follower compression therapy device 102. If new pair decision 238 results in a decision of no, do not establish a new pair link between leader compression therapy device 101 and a follower compression therapy device 102, leader compression therapy device 101 can maintain the pair link with the follower compression therapy device 102 found at follower finding step 232 and process 200 can proceed to panel control step 220. If new pair decision 238 results in a decision of yes, establish a new pair link between leader compression therapy device 101 and a follower compression therapy device 102, process 200 can proceed to new pair step 240.

New pair step 240 comprises leader compression therapy device 101 entering a pairing mode and attempting to find a follower compression therapy device 102 also in a pairing mode. New pair step 240 can also comprise a user interacting with a follower compression therapy device 102 to place the follower compression therapy device 102 into the pairing mode. Process 200 can proceed from new pair step 240 to new pair decision 242. New pair decision 242 comprises a determination of whether a follower compression therapy device 102 in pairing mode can be found to establish a new pair link with leader compression therapy device 101. New pair decision 242 can be made after searching for a follower compression therapy device 102 for a predetermined amount of time. The predetermined amount of time can be, for example, 10 seconds, 20 seconds, 30 seconds, or any other amount of time.

If new pair decision 242 results in a decision of no, no follower compression therapy device 102 in pairing mode can be found, process 200 can proceed to failed pair step 246. Failed pair step 246 comprises erasing existing pairing information, then proceeding to unpaired operation step 216.

If new pair decision step 242 results in a decision of yes, a follower compression therapy device 102 in pairing mode can be found, process 200 can proceed to successful pair step 244. Successful pair step 244 can comprise erasing existing pairing information and establishing a new pair link between leader compression therapy device 101 and the follower compression therapy device 102 found in new pair step 240. Process 200 can proceed from successful pair step 244 by proceeding to panel control step 220.

In other embodiments, existing pairing information can be erased at any time between a yes decision at new pair decision 238 and either failed pair step 246 or successful pair step 244 instead of the existing pairing information being erased during the failed pair step 246 or successful pair step 244 as described above.

FIG. 12B shows an operating process 300 for follower compression therapy device 102. Operating process 300 can be conducted by follower controller 175. Thus, steps and decisions of operating process 300 can be executed by follower controller 175 except as they relate to functions expressly attributed to a user or to other devices.

Operating process 300 can begin at an off state 310. In off state 310, follower compression therapy device 102 may be powered off. Off state 310 can be ended with an activation step 312. Activation step 312 can comprise powering follower compression therapy device 102 on. Activation step 312 can comprise, for example, flipping a power switch or pressing a power button of follower compression therapy device 102. In some embodiments, the power button can be follower button 177 of follower control assembly 178. As noted above, operating process 300 and its steps can be executed by follower controller 175, except for functions expressly reserved for a user or another device. Thus, to use activation step 312 as an example, a user may be responsible for providing the input that initiates activation step 312, and an on button, on switch, or other input hardware may be the device responsible for receiving the user's activating input, but follower controller 175 may execute startup functions following receipt of the activating input.

At any time after activation step 312, process 300 can proceed to deactivation step 330. Deactivation step 330 can comprise powering follower compression therapy device 102 off. Similar to activation step 312, deactivation step 330 can be initiated by a user providing a deactivating input such as, for example, flipping a power switch or pressing a power button of follower compression therapy device 102. In some embodiments, the power button can be a follower button 177 of follower control assembly 178. Deactivation step 330 can be initiated by the user providing the deactivation input in instances wherein deactivation step 330 is initiated by a user. However, in certain circumstances, process 300 can proceed automatically to deactivation step 330. In such circumstances, deactivation step 330 can comprise powering follower compression therapy device 102 off automatically, without user input.

Following activation step 312, process 300 can proceed to a current pair decision 314. Current pair decision 314 can comprise follower controller 175 determining whether follower compression therapy device 102 is currently paired to any leader compression therapy device 101 for wireless communication.

If current pair decision 314 results in a decision of no, follower compression therapy device 102 is not currently paired to any leader compression therapy device 101 for wireless communication, process 300 can proceed to idle state 316. Idle state 316 can comprise follower compression therapy device 102 remaining on for a predetermined period of time, then proceeding to deactivation step 330 if follower compression therapy device 102 is not placed into a pairing state or into active communication with a leader compression therapy device 101 within the predetermined amount of time. The predetermined amount of time can be, for example, one minute, two minutes, three minutes, four minutes, five minutes, six minutes, or any other amount of time.

A user can transition follower compression therapy device 102 from idle state 316 to a pairing state 320 by providing a pairing input to follower compression therapy device 102. In some embodiments, the pairing input can be made through follower control assembly 178. In some embodiments, the pairing input can be made through follower button 177. In embodiments wherein follower button 177 also functions as a power button for deactivation step 330, the pairing input can be different from an input to follower button 177 that would initiate deactivation step. For example, a first input can comprise pressing and releasing follower button 177 within a predetermined amount of time, and a second input can comprise pressing follower button 177 continuously for an amount of time exceeding the predetermined amount of time. In another example, the first or second input can comprise pressing follower button 177 a predetermined number of times within a second predetermined amount of time. The pairing input can be either the first or second input to follower button 177, and the input to initiate deactivation step 330 can be the other of the first input or the second input to follower button 177.

Following the transition to pairing state 320, process 300 can proceed to pairing decision 322. In some embodiments, process 300 can remain at pairing state 320 for a predetermined amount of time before proceeding to pairing decision 322. The predetermined amount of time can be, for example, one minute, two minutes, three minutes, four minutes, five minutes, six minutes, or any other amount of time.

Pairing decision 322 can comprise a determination of whether follower compression therapy device 102 could establish a new pair link with a leader compression therapy device 101. If pairing decision 322 results in a finding of no, follower compression therapy device 102 could not establish a new pair link with a leader compression therapy device 101, process 300 can proceed to failed pair step 324. Failed pair step 324 can comprise proceeding automatically to deactivation step 330.

If pairing decision 322 results in a decision of yes, follower compression therapy device 102 can establish a new pair link with a leader compression therapy device 101, process 300 can proceed to a successful pair step 326. Successful pair step 326 can comprise follower compression therapy device 102 erasing any existing pairing information it may have and establishing a new pair link with the leader compression therapy device 101 found in pairing state 320. Following successful pair step 326, follower compression therapy device 102 can return to current pair decision 314 and automatically reach a decision of yes, follower compression therapy device 102 is currently paired to a leader compression therapy device 101.

If current pair decision 314 results in a decision of yes, follower compression therapy device 102 is currently paired to a leader compression therapy device 101, process 300 can proceed to leader finding step 328. Leader finding step 328 can comprise follower compression therapy device 102 attempting to establish active communication with the paired leader compression therapy device 101. Process 300 may proceed from leader finding step 328 to leader finding decision 332. Leader finding decision 332 can comprise a determination of whether follower compression therapy device 102 was able to establish active communication with the paired leader compression therapy device 101.

If leader finding decision 332 results in a decision of no, follower compression therapy device 102 was not able to establish active communication with the paired leader compression therapy device 101, process 300 may proceed automatically to deactivation step 330. Follower compression therapy device 102 can be configured to remain at leader finding step 328 for a predetermined amount of time before reaching a “no” decision at leader finding decision 332. The predetermined amount of time can be, for example, one minute, two minutes, three minutes, four minutes, five minutes, six minutes, or any other amount of time. In some embodiments, a user can interrupt leader finding step 328 by entering the pairing input, forcing a “no” decision at leader finding decision 332 and causing follower compression therapy device 102 to enter pairing state 320.

If leader finding decision 332 results in a decision of yes, follower compression therapy device 102 was able to establish active communication with the paired leader compression therapy device 101, process 300 can proceed to mutual recognition step 334. In mutual recognition step 334, leader compression therapy device 101 and follower compression therapy device 102 confirm each other's identities and continue active communication.

Process 300 may proceed from mutual recognition step 334 to a paired operation step 336. Paired operation step 336 can comprise follower compression therapy device 102 operating according to instruction from leader compression therapy device 101. Accordingly, paired operation step 336 can comprise follower compression therapy device 102 applying therapy according to instructions received from leader compression therapy device 101. Follower compression therapy device 102 can remain at paired operation step 336 until user inputs cause follower compression therapy device 102 to transition to pairing state 320 or initiate deactivation step 330.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A compression therapy device, comprising:
an inflatable body enclosing an elongate passage defining an interior of the compression therapy device;
a liner attached to the inflatable body, wherein the liner comprises windows; and
a thigh emitter group and a calf emitter group, the thigh emitter group being positioned on the liner to provide infrared therapy to a wearer's thigh and the calf emitter group being positioned on the liner distally of the thigh emitter group to provide infrared therapy to a wearer's calf,
wherein the thigh emitter group and the calf emitter group each comprise elongate infrared emitters arranged about the elongate passage and configured to emit infrared radiation away from the inflatable body and into the elongate passage through the windows, wherein the elongate infrared emitters are substantially aligned with a lengthwise direction of the elongate passage.

2. The compression therapy device of claim 1, wherein the inflatable body comprises an interior facing side, and the infrared emitters are disposed between the windows and the interior facing side.

3. (canceled)

4. The compression therapy device of claim 1, comprising:
motor shells attached to the liner and interspersed among the elongate infrared emitters; and
vibration motors, wherein a respective one of the vibration motors is disposed within each motor shell.

5. The compression therapy device of claim 4, wherein each of the motor shells is constructed of a rigid material.

6. The compression therapy device of claim 1, wherein the liner comprises emitter covers extending across the windows to define a pocket between each of the emitter covers and a respective one of the windows, and the elongate infrared emitters are received in the pockets.

7. The compression therapy device of claim 6, wherein each of the pockets comprises an open end, and the compression therapy device comprises an elastic restrictor positioned at each of the open ends and configured to resist withdrawal of the elongate infrared emitters through the open ends.

8. (canceled)

9. (canceled)

10. A compression therapy system, comprising:
a leader device, wherein the leader device comprises:
a first compression sleeve;
a first pump configured to inflate the first compression sleeve; and
a first controller mounted to the first compression sleeve and configured to control the first pump;
a follower device, wherein the follower device comprises:
a second compression sleeve;
a second pump configured to inflate the second compression sleeve; and
a second controller mounted to the second compression sleeve and configured to control the second pump; and
a user interface system that is asymmetric with respect to the leader device and the follower device, wherein the user interface system comprises a first control panel mounted to the first compression sleeve, and wherein the first controller is configured to receive user inputs through the first control panel and relay commands based on the user inputs to the second controller such that the first controller controls the second pump through the second controller,
wherein the first control panel comprises a first user interface layout, and wherein the follower device lacks any control panel comprising the first user interface layout.

11. The compression therapy system of claim 10, wherein:
the leader device comprises a first infrared emitter configured to emit infrared radiation into an interior of the first compression sleeve;
the follower device comprises a second infrared emitter configured to emit infrared radiation into an interior of the second compression sleeve; and
the first controller is configured to control the first infrared emitter, and the first controller is configured to control the second infrared emitter through the second controller.

12. The compression therapy system of claim 10, wherein the first control panel comprises a first user interface layout, the user interface system comprises a second control panel comprising a second user interface layout that differs from the first user interface layout, and the second control panel is mounted to the second compression sleeve.

13. (canceled)

14. A compression therapy device, comprising:
a sleeve that comprises an inflatable body, wherein the sleeve defines an interior space that the inflatable body is configured to constrict, and the inflatable body comprises an interior facing side;
a liner attached to the inflatable body and positioned to cover a portion of the interior facing side of the inflatable body;
infrared emitters connected to the liner and arranged circumferentially about the interior space, wherein the infrared emitters are spaced circumferentially apart from one another; and
vibration motors connected to the liner and arranged circumferentially about the interior space and in spaces defined circumferentially between the infrared emitters.

15. The compression therapy device of claim 14, comprising a controller configured to control the vibration motors, wherein the controller is configured to only activate the vibration motors when the inflatable body is inflated to at least a predetermined internal pressure.

16. The compression therapy device of claim 14, comprising rigid motor shells attached to the liner, wherein each of the vibration motors is attached to the liner by being received within a respective one of the rigid motor shells.

17. The compression therapy device of claim 16, wherein the rigid motor shells are located between the liner and the interior facing side.

18. The compression therapy device of claim 14, wherein the infrared emitters comprise a first infrared emitter configured to emit infrared radiation away from the interior facing side of the inflatable body through the liner.

19. The compression therapy device of claim 18, wherein the liner comprises a sheet, a slot formed in the sheet, and a window transparent to a spectrum of infrared radiation, and the first infrared emitter is configured to emit infrared radiation through the window.

20. A compression therapy system, comprising:
the compression therapy device of claim 14, wherein the compression therapy device is a follower compression therapy device, the sleeve is a follower sleeve configured to receive a first limb of a user, and the inflatable body is a follower inflatable body; and
a leader compression therapy device, wherein the leader compression therapy device comprises a leader controller and a leader sleeve that comprises a leader inflatable body, wherein the leader sleeve is configured to receive a second limb of the user and defines an interior space that the inflatable body is configured to constrict, and the leader controller is configured to control the infrared emitters and the vibration motors of the follower compression therapy device.

21. The compression therapy system of claim 10, wherein the leader device comprises the first control panel.
